(19) United States
(12) Patent Application Publication
(10) Pub. No.: US 2026/0298018 A1
(43) Pub. Date: Oct. 1, 2026

(54) PANEL STRUCTURE, DOOR PANEL, AND METHOD OF MANUFACTURING PANEL STRUCTURE

(71) Applicant: FUJI ELECTRIC CO., LTD., Kawasaki-shi (JP)

(72) Inventors: Yoko TANAKA, Kawasaki-shi (JP); Naohiro JINNAI, Kawasaki-shi (JP); Yasuhito TANAKA, Kawasaki-shi (JP)

(73) Assignee: FUJI ELECTRIC CO., LTD., Kawasaki-shi (JP)

(21) Appl. No.: 19/562,235

(22) Filed: Mar. 10, 2026

(30) Foreign Application Priority Data
Mar. 25, 2025 (JP) 2025-049429
Jul. 3, 2025 (JP) 2025-112784

(51) Int. Cl. E06B 3/70

(52) U.S. Cl. CPC E06B 3/7015; E06B 2003/7019; E06B 2003/703; E06B 2003/7051

(57) ABSTRACT

A panel structure including: a first surface plate and a second surface plate forming a pair; and a core plate disposed between the first and second surface plates, the core plate having a plurality of protrusions arranged in a matrix on a first main surface thereof facing the first surface plate. Each of the plurality of protrusions has a protrusion tip surface facing the first surface plate. The core plate and the first surface plate are bonded to each other such that each of the protrusion tip surfaces is in contact with the first surface plate and is constrained by a plurality of planar separate constraint regions corresponding to a planar shape of said each protrusion tip surface.

### CROSS-REFERENCE TO RELATED APPLICATIONS

This application is based upon and claims the benefit of priority to Japanese Patent Application Nos. 2025-049429, filed on Mar. 25, 2025 and 2025-112784, filed on Jul. 3, 2025, the entire contents of which are incorporated herein by reference.

### BACKGROUND OF THE INVENTION

### 1. Technical Field

The present invention relates to a panel structure, a door panel, and a method of manufacturing the panel structure.

### 2. Description of the Related Art

A panel structure includes a pair of surface materials and a core material disposed between the pair of surface materials, and has increased rigidity thereof by bonding the core material to the surface materials with an adhesive (for example, JP 2023-62745 A and JP 2004-339778A).

In addition, as a panel structure in which a core material is disposed between a pair of surface materials, there is a panel structure in which a corrugated honeycomb core in which a plurality of groove-shaped materials are disposed in parallel is used as the core material, and the groove-shaped materials and the surface materials are bonded to each other by welding (JP H5-269898A). As a similar panel structure, there is a panel structure in which a folded plate bent in a corrugated shape is welded to a plate body to increase shear resistance (JP 2007-162430 A). Further, examples of the core material disposed between the pair of surface materials include a core material (JP 2016-29235 A) constituted by a large number of regularly arranged regular hexagonal cells, and a core material (JP H10-166481 A) in which pyramid-shaped quadrangular pyramids are alternately arranged upward and downward. In addition, for example, there is a panel structure using a cap sheet in which a plurality of protrusions bulging in a hollow shape are formed as a core material (JP 2013-75451 A).

### SUMMARY OF THE INVENTION

In the panel structures disclosed in JP 2023-62745 A and JP 2004-339778 A, since the adhesive is used for the surface materials and the core material, a mass (weight) of the panel structure increases. In addition, the use of the adhesive causes problems such as an increase in manufacturing cost and a decrease in manufacturing efficiency.

Furthermore, the panel structure in which the pair of surface materials and the core material are metal, as disclosed in JP H5-269898 A, has higher rigidity and strength than the panel structure using the core material made of paper or synthetic resin, as disclosed in JP 2016-29235A, JP H10-166481 A, and JP 2013-75451 A. However, the panel structure in which the metal core material and the metal surface materials are bonded to each other by welding may have low rigidity and strength depending on a welding method.

The present invention has been made in view of such a point, and an object of the present invention is to provide a lightweight panel structure having high rigidity.

A panel structure according to one aspect of the present invention includes a first surface plate and a second surface plate forming a pair; and a core plate disposed between the first and second surface plates, the core plate having a plurality of protrusions arranged in a matrix on a first main surface thereof facing the first surface plate. Each of the plurality of protrusions has a protrusion tip surface facing the first surface plate. The core plate and the first surface plate are bonded to each other such that each of the protrusion tip surfaces is in contact with the first surface plate and is constrained by a plurality of planar separate constraint regions corresponding to a planar shape of said each protrusion tip surface.

According to the present invention, it is possible to provide a lightweight panel structure having high rigidity.

### BRIEF DESCRIPTION OF THE DRAWINGS

FIG. 1 is a front view illustrating a configuration example of a door panel to which a panel structure according to an embodiment is applied;

FIG. 2 is an exploded perspective view illustrating an example of a core material in a panel structure according to a first embodiment;

FIGS. 3A and 3B are a front view (FIG. 3A) and a side sectional view (FIG. 3B) illustrating a configuration example of a protrusion on the core material;

FIG. 4 is a flowchart for description of a method of manufacturing the door panel in FIG. 1;

FIGS. 5A and 5B are side sectional views illustrating a method of producing the core material;

FIGS. 6A and 6B are side sectional views illustrating a step of welding the core material to a surface material;

FIG. 7 is a front view illustrating a modification of arrangement of the protrusions on the core material according to the first embodiment;

FIGS. 8A and 8B are front views illustrating a first configuration example (FIG. 8A) and a second configuration example (FIG. 8B) of a protrusion on a core material according to a second embodiment;

FIG. 9 is a front view illustrating a configuration example of a protrusion on a core material according to a third embodiment;

FIGS. 10A and 10B are a front view (FIG. 10A) and a side sectional view (FIG. 10B) illustrating a configuration example of a protrusion on a core material according to a fourth embodiment;

FIG. 11 is an exploded perspective view illustrating a configuration example of a panel structure according to a fifth embodiment;

FIGS. 12A and 12B are plan views exemplifying shapes of a welded portion between a first surface material and a core material in the panel structure in FIG. 11;

FIGS. 13A and 13B are plan views exemplifying shapes of a welded portion between a second surface material and the core material in the panel structure in FIG. 11;

FIG. 14 is a side sectional view of the panel structure taken along an alternated long and short dash line C-C′ in FIG. 12A;

FIGS. 15A and 15B are plan views illustrating an example of a method of manufacturing the panel structure according to the fifth embodiment;

FIGS. 16A and 16B are side sectional views illustrating an example of the method of manufacturing the panel structure according to the fifth embodiment;

FIGS. 17A and 17B are diagrams illustrating rigidity of a panel structure in which a surface material and a core material are bonded to each other by spot welding;

FIGS. 18A and 18B are diagrams illustrating a conventional example of a panel structure in which a surface material and a core material are bonded to each other by seam welding;

FIGS. 19A to 19C are diagrams illustrating rigidity of the panel structure according to the fifth embodiment;

FIGS. 20A and 20B are diagrams illustrating additional welded portions in the panel structure according to the fifth embodiment;

FIGS. 21A and 21B are diagrams illustrating a first modification of arrangement of protruding portions on the core material of the panel structure according to the fifth embodiment;

FIGS. 22A and 22B are diagrams illustrating an example of seam welding between a second surface material and the core material in the panel structure using the core material exemplified in FIGS. 21A and 21B; and

FIGS. 23A and 23B are diagrams illustrating another modification of a shape and arrangement of the protruding portions on the core material of the panel structure according to the fifth embodiment.

### DETAILED DESCRIPTION

Hereinafter, embodiments of the present invention will be described in detail with reference to the drawings. An X axis, a Y axis, and a Z axis in each of the drawings to be referred to are illustrated for the purpose of defining planes and directions in an exemplified panel structure or the like. The X axis, the Y axis, and the Z axis are orthogonal to each other and form a right-handed system. In the following description, a direction parallel to the X axis is referred to as an X direction, a direction parallel to the Y axis is referred to as a Y direction, and a direction parallel to the Z axis is referred to as a Z direction. In addition, in a case in which each of the X direction, the Y direction, and the Z direction is associated with a direction of an arrow (positive or negative) of the X axis, the Y axis, and the Z axis illustrated in the drawing, a “positive side” or a “negative side” is attached. In the present specification, the X direction may be referred to as a lateral direction, and the Y direction may be referred to as a longitudinal direction. Furthermore, in the present specification, the Z direction may be referred to as a stacking direction. In addition, an aspect ratio and a magnitude relationship between members in each drawing are merely schematically represented, and do not necessarily coincide with a relationship in a panel structure to be actually manufactured. For convenience of description, it is also assumed that the magnitude relationship between members is exaggerated.

### First Embodiment

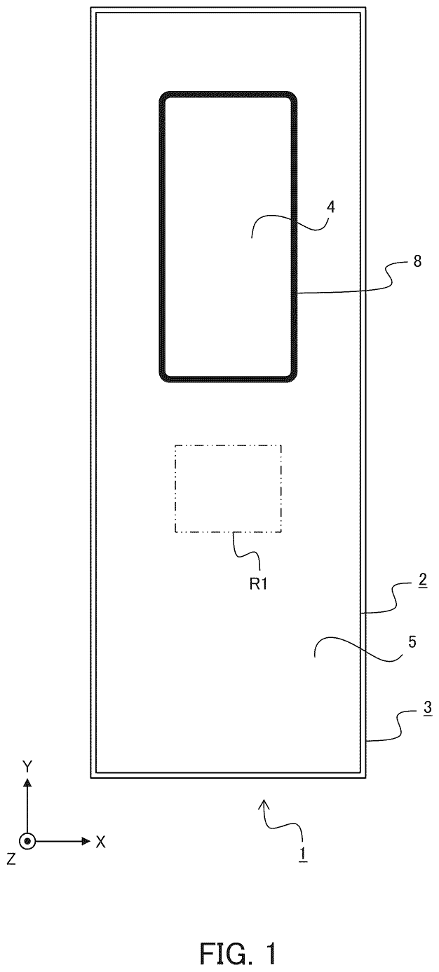

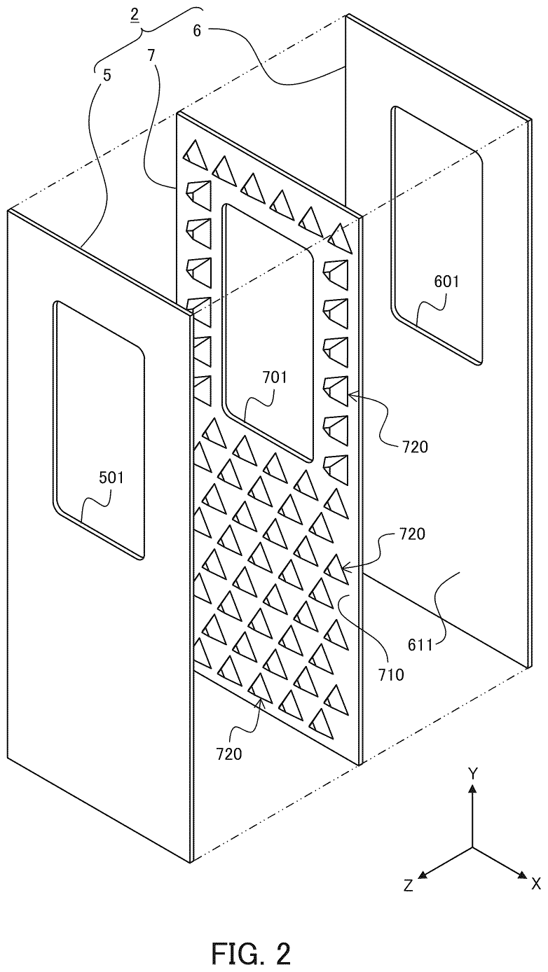

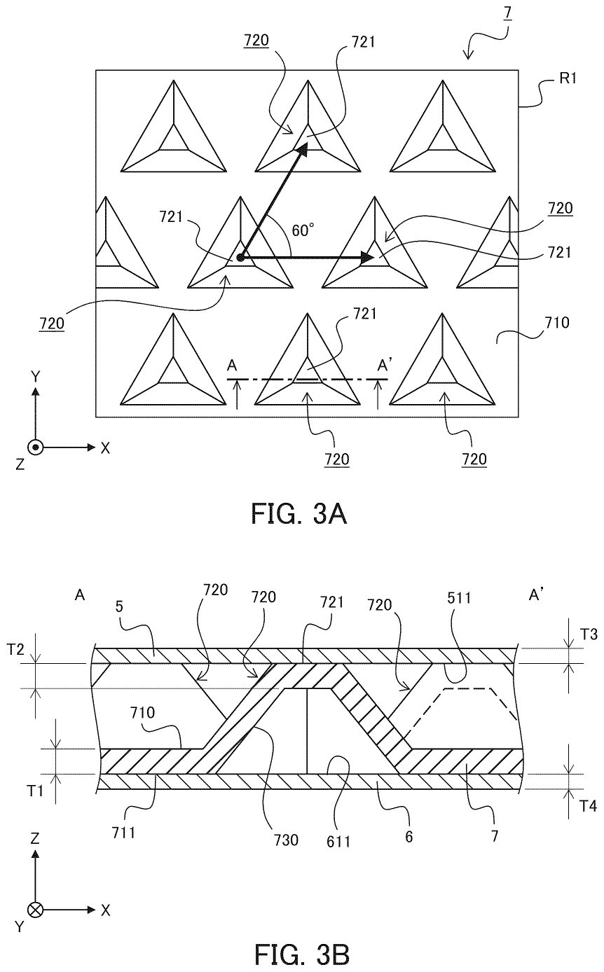

FIG. 1 is a front view illustrating a configuration example of a door panel to which a panel structure according to an embodiment is applied. FIG. 2 is an exploded perspective view illustrating an example of a core material in a panel structure according to a first embodiment. FIGS. 3A and 3B are a front view (FIG. 3A) and a side sectional view (FIG. 3B) illustrating a configuration example of a protrusion on the core material. The front view in FIG. 3A schematically illustrates a configuration example of the protrusion on the core material in a region R1 in FIG. 1. The side sectional view in FIG. 3B schematically illustrates a configuration example of a cross section and a back portion of a panel structure 2 cut at a position of an alternate long and short dash line A-A′ in FIG. 3A.

A door panel 1 illustrated in FIG. 1 includes the panel structure 2, a frame 3, and a window glass 4. The door panel 1 can be applied to, for example, a door of a railway vehicle. For example, as illustrated in FIG. 2, the panel structure 2 includes a pair of surface materials (i.e., surface plates) 5 and 6 and a core material (i.e., core plate) 7 disposed between the pair of surface materials 5 and 6. The pair of surface materials 5 and 6 and the core material 7 are formed such that opening regions 501, 601, and 701 for providing windows overlap each other, and the window glass 4 is fitted in these opening regions and integrated with the panel structure 2 by a sealing material 8. The frame 3 is a support member that supports the panel structure 2 in an article to which the door panel 1 is applied. The frame 3 in the door panel 1 applied to a door of a railway vehicle can be one of the members for supporting the panel structure 2 on a main body of the railway vehicle in an openable-and-closable manner. The panel structure 2 in FIG. 2 is merely an example of the panel structure 2 to which the core material 7 according to the first embodiment and the core material 7 according to embodiments to be described later can be applied. The panel structure 2 only needs to include the pair of surface materials 5 and 6 and the core material 7 disposed between the pair of surface materials 5 and 6, and application thereof is not limited to the door panel 1 for a door of a railway vehicle. The panel structure 2 may be applied to, for example, a door panel such as a door of a building. In the panel structure 2, an opening region into which the window glass 4 is fitted may be omitted. The panel structure 2 in which the opening region into which the window glass 4 is fitted is omitted may be applied to, for example, a partition installed in a room. The panel structure 2 may be applied to, for example, a panel material constituting a housing of an electric board, a vending machine, a showcase, or the like. In the following description, when referring to one surface material of the pair of surface materials 5 and 6, one surface material 5 is referred to as a first surface material 5, and the other surface material 6 is referred to as a second surface material 6.

The core material 7 of the panel structure 2 according to the first embodiment is made of, for example, thermoplastic resin such as polyethylene or polypropylene. As described later, the core material 7 is welded to each of the pair of surface materials 5 and 6. “Welding” in the present specification is intended to mean bonding by heating and melting a contact surface of the core material 7 formed of thermoplastic resin with the first surface material 5 or the second surface material 6, and a state in which the core material 7 and the first surface material 5 or the second surface material 6 are bonded to each other in such a manner. Therefore, the pair of surface materials 5 and 6 can be metal plates such as a stainless steel plate and an aluminum plate having a melting point higher than that of the thermoplastic resin used for forming (producing) the core material 7. A plurality of protrusions 720 are provided on a first main surface 710 of the core material 7, which faces the first surface material 5. The protrusion 720 may be referred to as a protruding portion 720. FIG. 3A illustrates an example in which the plurality of protrusions 720 on the first main surface 710 are arranged in a truss arrangement (array). The protrusion 720 according to the first embodiment is formed such that a protrusion tip surface 721 has a truncated triangular pyramid shape and is tapered from the first main surface 710 toward the protrusion tip surface 721. For example, as illustrated in FIG. 3B, the protrusion 720 is formed by deforming a predetermined region of the flat-plate-like (sheet-like) core material 7 having a thickness T1 so as to protrude from the first main surface 710. For this reason, in a second main surface 711 of the core material 7 facing the second surface material 6, a recessed portion 730 that defines a space of a truncated triangular pyramid, which is similar or analogous to the protrusion 720, is formed in a region on the opposite side of the protrusion 720 on the first main surface 710 in a plan view of the second main surface 711. The thickness T1 of the core material 7 is intended to mean a distance from the first main surface 710 to the second main surface 711 on the opposite side in a portion of the core material 7 where the protrusion 720 is not formed. A thickness T2 of a protrusion tip portion of the protrusion 720 may be the same as or different from the thickness T1 of the core material 7. In addition, the thickness T1 of the core material 7 is not restricted to being greater than a thickness T3 of the first surface material 5 and a thickness T4 of the second surface material 6 as exemplified in FIG. 3B. Further, the arrangement of the plurality of protrusions 720 on the first main surface 710 of the core material 7 is not limited to the truss arrangement (array) illustrated in FIG. 3A.

The plurality of protrusions 720 on the core material 7 have substantially the same height from the first main surface 710, and the protrusion tip surfaces 721 of the protrusions 720 are welded to a main surface 511 of the first surface material 5, which faces the core material 7. In other words, the core material 7 and the first surface material 5 are bonded to each other such that each of the protrusion tip surfaces 721 of the plurality of protrusions 720 on the core material 7 is in contact with the main surface 511 of the first surface material 5 and is constrained by a plurality of separate planar constraint regions corresponding to planar shapes of the protrusion tip surfaces 721. The second main surface 711 of the core material 7 is welded to a main surface 611 of the second surface material 6, which faces the core material 7. The heights of the plurality of protrusions 720 are set according to a distance from the main surface 511 of the first surface material 5 to the main surface 611 of the second surface material 6 in the panel structure 2 to be manufactured and the thickness T1 of the core material 7 to be used. A size of each protrusion 720, an area of the protrusion tip surface 721, an arrangement interval of the protrusions 720, and the like can be set according to, for example, the application, required rigidity, and the like of the panel structure 2, and are not limited to specific values.

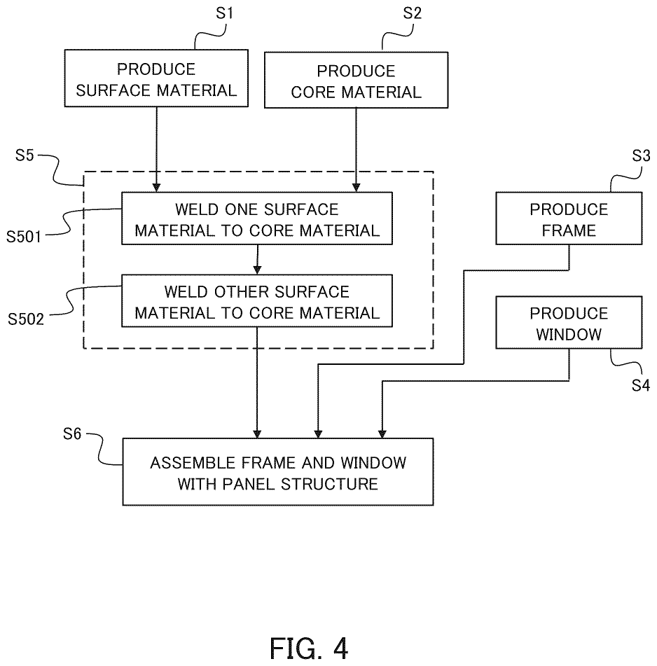

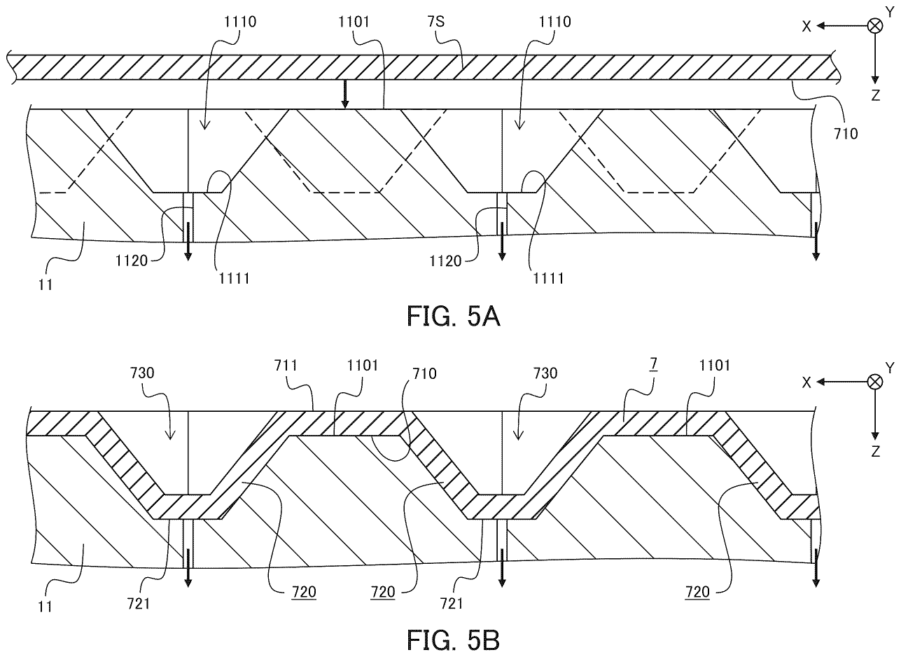

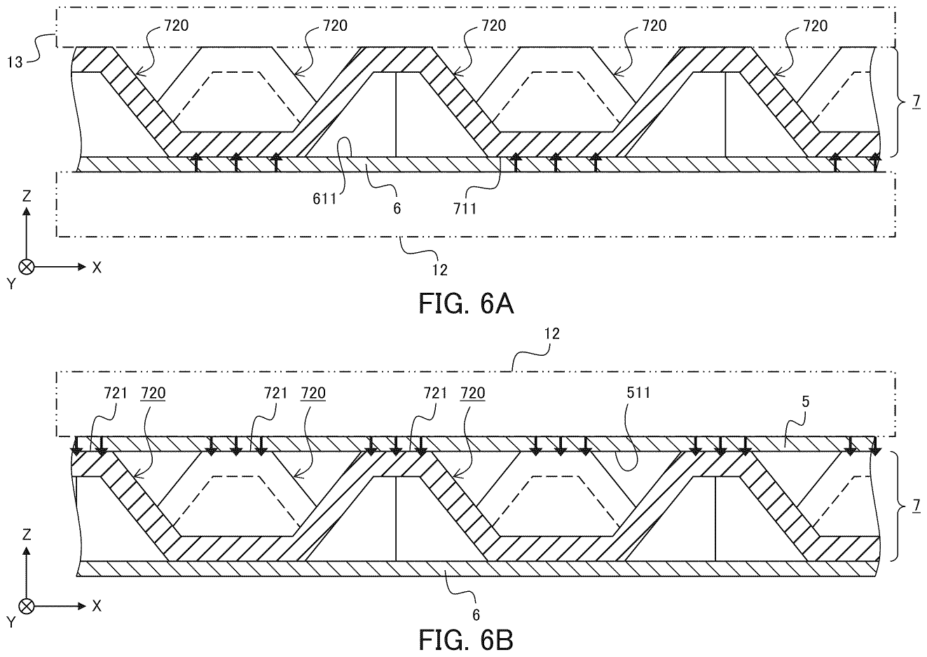

FIG. 4 is a flowchart for description of a method of manufacturing the door panel in FIG. 1. FIGS. 5A and 5B are side sectional views illustrating a method of producing the core material. FIGS. 6A and 6B are side sectional views illustrating a step of welding the core material to the surface material.

The panel structure 2 including the core material 7 according to the first embodiment and the door panel 1 to which the panel structure 2 including the core material 7 according to the embodiments to be described later is applied are manufactured by, for example, procedures illustrated in FIG. 4. A manufacturing step of the door panel 1 includes a first step S1 of producing the pair of surface materials 5 and 6, a second step S2 of producing the core material 7, a third step S3 of producing the frame 3, and a fourth step S4 of producing the window glass 4. In each of the first step S1, the third step S3, and the fourth step S4, each step in a known manufacturing step can be applied, and thus detailed description of these steps is omitted in the present specification. In a case in which the door panel 1 to be manufactured does not have a window, the fourth step S4 is omitted.

In the second step S2, the core material 7 having the protrusions 720 described above with reference to FIGS. 3A and 3B is produced by thermoplastic resin. The core material 7 can be produced by a known method such as vacuum molding or pressure molding using sheet-like thermoplastic resin as a material. When the core material 7 is produced by vacuum molding, for example, as illustrated in FIG. 5A, a sheet material 7S made of thermoplastic resin, which has been heated and softened, is disposed on a mold 11 for molding. The sheet material 7S is obtained by, for example, molding thermoplastic resin such as polyethylene (PE) or polypropylene (PP) into a sheet shape having a predetermined thickness. In the case of the polyethylene sheet material 7S, for example, the sheet material 7S is softened at about 90° C. In the case of the polypropylene sheet material 7S, for example, the sheet material 7S is softened at about 110° C. to 150° C. In an upper surface 1101 of the mold 11, a plurality of recessed portions 1110 for forming the plurality of protrusions 720 on the first main surface 710 of the sheet material 7S facing the upper surface 1101 are formed. An opening end of a through hole 1120 for vacuum suction is formed in a bottom surface 1111 of each of the plurality of recessed portions 1110. When vacuum suction using the through hole 1120 is performed in a state in which the softened sheet material 7S is placed on the upper surface 1101 of the mold 11, as illustrated in FIG. 5B, a portion of the sheet material 7S on the opening region of the recessed portion 1110 is suctioned into the recessed portion 1110, and for example, the protrusion 720 having a truncated triangular pyramid shape is formed. The method of producing the core material 7 is not limited to a specific method. For example, the core material 7 may be produced by press molding in which the sheet material 7S made of thermoplastic resin is sandwiched between a pair of molds including an upper mold and a lower mold.

After the core material 7 is produced by the above-described procedure, a fifth step (welding step) S5 of arranging and welding the core material 7 between the pair of surface materials 5 and 6 produced by a known method in the first step S1 can be performed. Since the welding in the present specification is an example of bonding as described above, the welding step may be referred to as a bonding step. The fifth step S5 can include a first welding step S501 of welding the core material 7 to one surface material (for example, the second surface material 6) of the pair of surface materials 5 and 6, and a second welding step S502 of welding the core material 7 to the other surface material (for example, the first surface material 5). In the first welding step S501, for example, as illustrated in FIG. 6A, the second main surface 711 (the main surface opposite to the first main surface 710 on which the protrusions 720 are disposed) of the core material 7 is brought into contact with the main surface 611 of the second surface material 6, and the second surface material 6 is heated by a heating unit 12. At this time, the entire surface of the second main surface 711 of the core material 7 is brought into close contact with the main surface 611 of the second surface material 6 by a pressing jig 13. The pressing jig 13 applies, for example, a relatively small pressing load that does not cause plastic deformation of the plurality of protrusions 720 on the core material 7 to the core material 7. When the core material 7 formed of thermoplastic resin is welded to the second surface material 6, the core material 7 is heated at a temperature higher than a melting point of the core material 7 and lower than a melting point of the second surface material 6. In a case in which the core material 7 is made of polyethylene, for example, the second main surface 711 of the core material 7 is heated to 220° C. to 280° C. through the second surface material 6, and the second main surface 711 of the core material 7 is welded to the second surface material 6. In a case in which the core material 7 is made of polypropylene, for example, the second main surface 711 of the core material 7 is heated to 230° C. to 280° C. through the second surface material 6, and the second main surface 711 of the core material 7 is welded to the second surface material 6. In the second welding step S502 subsequent to the first welding step S501, for example, as illustrated in FIG. 6B, the protrusion tip surface 721 of the protrusion 720 disposed on the first main surface 710 of the core material 7 is brought into contact with the main surface 511 of the first surface material 5, and the first surface material 5 is heated by the heating unit 12. In the second welding step S502, for example, a pressing jig (not illustrated) is pressed against the second surface material 6, and the protrusion tip surface 721 of each of the plurality of protrusions 720 on the first main surface 710 is brought into close contact with the main surface 511 of the first surface material 5. As described above, in the fifth step (welding step) S5, by heating the first surface material 5 and the second surface material 6, the core material 7 made of thermoplastic resin and disposed between the surface materials 5 and 6 is heated and welded to each of the pair of surface materials 5 and 6. A shape of the protrusion tip surface 721 of the protrusion 720 after being welded to the first surface material 5 may be a shape that can be substantially regarded as a triangle although a triangle having a corner as illustrated in FIG. 3A may not be maintained. The fifth step S5 is not limited to the above-described procedure, and the step of welding the core material 7 to the first surface material 5 may be performed first, or the core material 7 may be welded to the first surface material 5 and the second surface material 6 at once.

After the fifth step S5, a sixth step S6 of assembling the frame 3, the window glass 4, and the like with the panel structure 2 in which the core material 7 is disposed between the pair of surface materials 5 and 6 can be performed. Since a well-known step can be applied to the sixth step S6, the detailed description of the sixth step S6 is omitted in the present specification.

As described above, since the panel structure 2 according to the first embodiment is produced (manufactured) by welding the core material 7 made of thermoplastic resin to each of the pair of surface materials 5 and 6, the panel structure 2 can be reduced in weight as compared with a case in which a core material formed of a metal-based material is used. In addition, in the method of manufacturing the panel structure 2 according to the embodiment, an adhesive for bonding a surface material to a core material as disclosed in JP 2023-62745 A and JP 2004-339778 A is unnecessary. Therefore, for example, as compared with a configuration in which a honeycomb-shaped core material is bonded to the entire surfaces of the surface materials 5 and 6 with an adhesive as disclosed in JP 2023-62745 A, the panel structure 2 can be further reduced in weight because an adhesive is not used. Further, as illustrated in FIG. 3A, the protrusion tip surfaces 721 of the plurality of protrusions 720, which are welded to the first surface material 5 in the core material 7 according to the first embodiment, are arranged in a two-dimensional lattice pattern (matrix pattern) on the first main surface 710 of the core material 7. Therefore, the panel structure 2 to which the core material 7 according to the first embodiment is applied can have high rigidity in both the longitudinal direction and the lateral direction. Therefore, for example, the rigidity of the panel structure 2 can be increased as compared with a case in which a core material extending in a longitudinal direction of a surface material is bonded to the surface material, as disclosed in JP 2004-339778 A. Furthermore, in the method of manufacturing the panel structure 2 using the core material 7 formed of thermoplastic resin, the core material 7 can be welded by heating the entire pair of surface materials 5 and 6. Therefore, for example, since the operation of uniformly applying an adhesive to the whole surfaces of the surface materials 5 and 6 can be omitted, the number of steps can be reduced, the time required for manufacturing can be shortened, and deterioration in manufacturing efficiency can be prevented. In addition, the method of manufacturing the panel structure 2 according to the first embodiment can prevent an increase in manufacturing cost due to use of an adhesive as compared with, for example, a method in which a honeycomb-shaped core material is bonded to the whole surfaces of the surface materials 5 and 6 with an adhesive, as disclosed in JP 2023-62745 A.

The method of manufacturing the door panel 1 described above with reference to FIG. 4 is merely an example of the method for manufacturing the door panel 1 including the panel structure 2 to which the core material 7 according to the first embodiment is applied. The method of manufacturing the door panel 1 is not limited to a manufacturing method in which all of the plurality of steps described above are performed as a series of operations by a single manufacturing entity. For example, one or more steps of the first step S1, the second step S2, the third step S3, and the fourth step S4 may be replaced with a step of obtaining a prepared product. That is, a manufacturer who produces (manufactures) the core material 7 and a manufacturer who welds the core material 7 to the pair of surface materials 5 and 6 may be different.

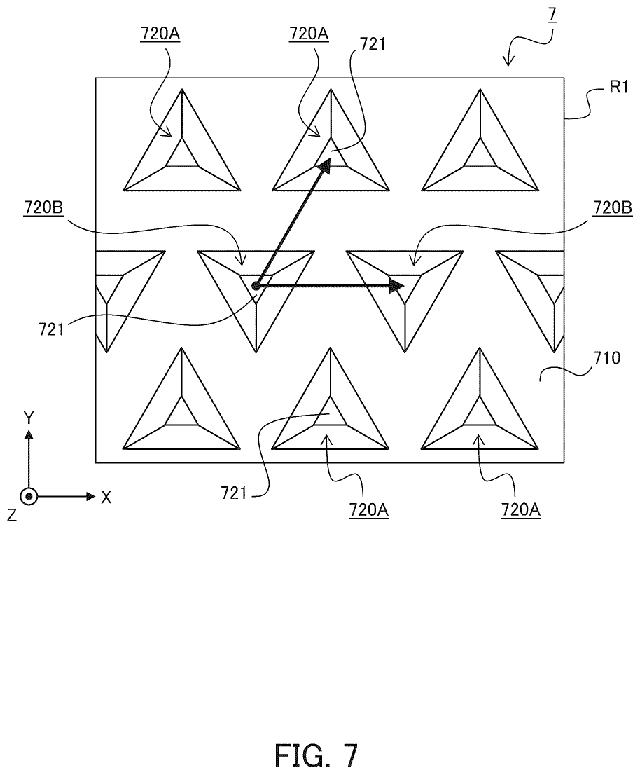

FIG. 7 is a front view illustrating a modification of the arrangement of the protrusions on the core material according to the first embodiment. FIG. 7 schematically illustrates a modification of the arrangement of the protrusions 720 on the core material 7 in the region R1 in FIG. 1. The arrangement of the protrusions 720 when the plurality of truncated triangular pyramid protrusions 720 are formed on the first main surface 710 of the core material 7 is not limited to the arrangement illustrated in FIG. 3A. In the plurality of protrusions 720, for example, as illustrated in FIG. 7, protrusions 720A in a first direction and protrusions 720B in a second direction having different positional relationships of three vertices of the protrusion tip surfaces 721 in a plan view of the first main surface 710 may be arranged according to a predetermined arrangement rule. The arrangement of the plurality of protrusions 720 only needs to be a matrix shape, and is not limited to the arrangement in which the plurality of protrusion tip surfaces 721 form the truss arrangement, as illustrated in FIGS. 3A and 7. In addition, for example, in the plurality of protrusions 720, the area of the protrusion tip surfaces 721 and an arrangement density thereof may be modified depending on positions thereof within the first main surface 710. Further, the shape of the protrusion 720 is not limited to the truncated triangular pyramid illustrated in FIGS. 3A and 7. The shape of the protrusion 720 may be, for example, a triangular prism.

### Second Embodiment

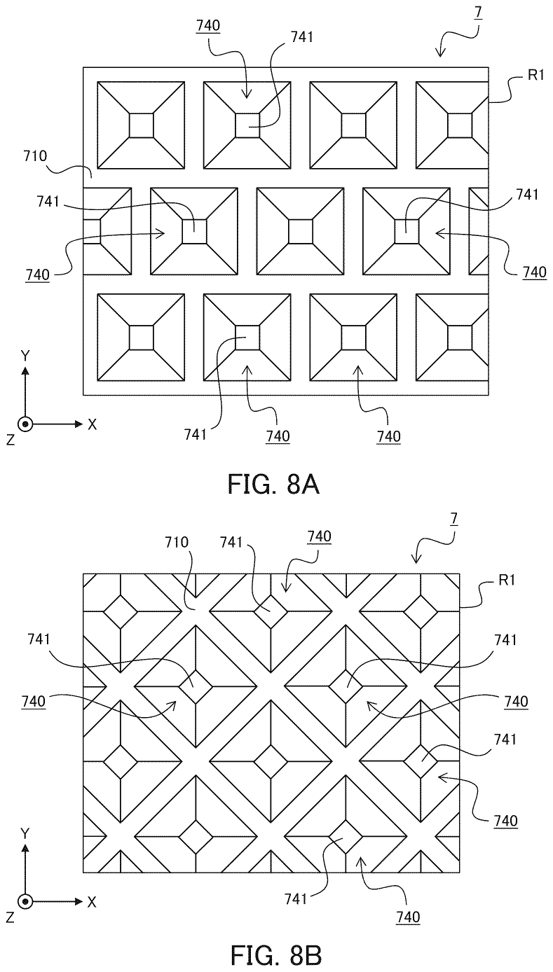

FIGS. 8A and 8B are front views illustrating a first configuration example (FIG. 8A) and a second configuration example (FIG. 8B) of a protrusion on a core material according to a second embodiment. FIGS. 8A and 8B schematically illustrate examples of a shape and arrangement of the protrusions on the core material 7 in the region R1 in FIG. 1, respectively.

In the core material 7 according to the second embodiment, for example, a plurality of truncated quadrangular pyramid protrusions 740 are formed on the first main surface 710, as illustrated in FIG. 8A. Although not illustrated, similarly to the protrusion 720 exemplified in the first embodiment, the protrusion 740 is formed by deforming a portion of the sheet material 7S made of thermoplastic resin, where the protrusion 740 is disposed, in a direction protruding from the first main surface 710. Therefore, a recessed portion that defines a space of a truncated quadrangular pyramid, which is similar or analogous to the protrusion 740, is formed in the second main surface 711 of the core material 7. Similarly to the core material 7 described in the first embodiment, such a core material 7 can be produced by vacuum molding, pressure molding, or the like using the sheet material 7S made of thermoplastic resin.

In the plurality of protrusions 740 illustrated in FIG. 8A, four sides of a protrusion tip surface 741, which is a quadrangle (square), are arranged in a direction in which a pair of sides extending in the lateral direction (X direction) and a pair of sides extending in the longitudinal direction (Y direction) are combined. In addition, the plurality of protrusions 740 illustrated in FIG. 8A are arranged on the first main surface 710 of the core material 7 such that the protrusion tip surfaces 741 form the truss arrangement. The panel structure 2 to which the core material 7 according to the second embodiment is applied can be reduced in weight while increasing rigidity in both the lateral direction and the longitudinal direction. Note that the arrangement of the protrusions 740 on the core material 7 according to the second embodiment only needs to be a matrix shape, and is not limited to the truss arrangement. For example, as illustrated in FIG. 8B, the plurality of truncated quadrangular pyramid protrusions 740 may be arranged in a direction in which four sides of the protrusion tip surface 741 extend in a direction inclined by 45° with respect to the lateral direction (X direction) and the longitudinal direction (Y direction). In addition, the truncated quadrangular pyramid protrusion 740 may have, for example, a shape in which the protrusion tip surface 741 is rectangular. Further, the protrusion 740 having the quadrangular protrusion tip surface 741 is not limited to a truncated quadrangular pyramid, and may be a quadrangular prism. In the second embodiment, a truncated quadrangular pyramid is exemplified as an example of the shape of the protrusion different from the truncated triangular pyramid protrusion 720 exemplified in the first embodiment. However, the protrusion tip surface of the protrusion disposed on the first main surface 710 of the core material 7, which is to be welded to the first surface material 5, may be any polygonal shape.

### Third Embodiment

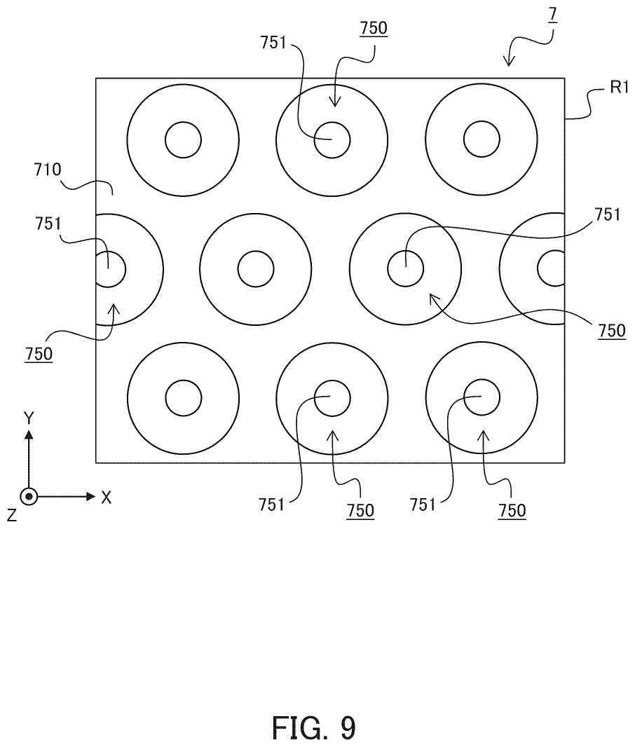

FIG. 9 is a front view illustrating a configuration example of a protrusion on a core material according to a third embodiment. FIG. 9 schematically illustrates an example of a shape and arrangement of the protrusions on the core material 7 in the region R1 in FIG. 1.

The core material 7 according to the third embodiment may be, for example, a core material in which a plurality of truncated conical protrusions 750 are formed on the first main surface 710, as illustrated in FIG. 9. Although not illustrated, similarly to the protrusion 720 exemplified in the first embodiment, the protrusion 750 is formed by deforming a portion of the sheet material 7S made of thermoplastic resin, where the protrusion 750 is disposed, in a direction protruding from the first main surface 710. Therefore, a recessed portion that defines a truncated conical space, which is similar or analogous to the protrusion 750, is formed in the second main surface 711 of the core material 7. Similarly to the core material 7 described in the first embodiment, such a core material 7 can be produced by vacuum molding, pressure molding, or the like using the sheet material 7S made of thermoplastic resin.

The plurality of protrusions 750 exemplified in FIG. 9 are arranged on the first main surface 710 of the core material 7 such that protrusion tip surfaces 751 are arranged in the truss arrangement. The panel structure 2 to which the core material 7 according to the third embodiment is applied can be reduced in weight while increasing rigidity in both the lateral direction and the longitudinal direction. Note that the arrangement of the protrusions 750 on the core material 7 according to the third embodiment may be in a matrix arrangement, and is not limited to the truss arrangement. Further, the truncated conical protrusion 750 may have, for example, a shape in which the protrusion tip surface 751 is elliptical (oval). Furthermore, the protrusion 750 having the circular protrusion tip surface 751 is not limited to a truncated cone, and may be a cylinder.

### Fourth Embodiment

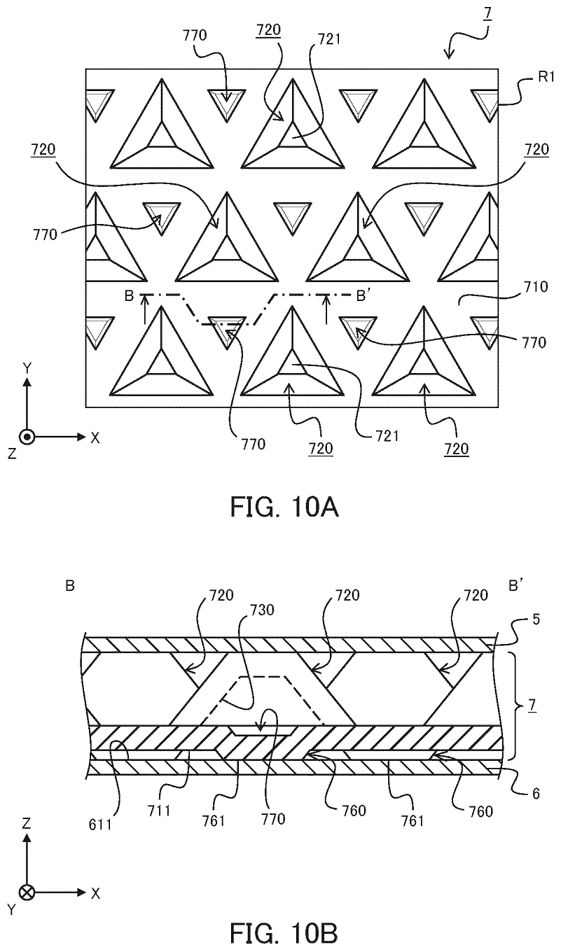

FIGS. 10A and 10B are a front view (FIG. 10A) and a side sectional view (FIG. 10B) illustrating a configuration example of a protrusion on a core material according to a fourth embodiment. The front view in FIG. 10A schematically illustrates a configuration example of the protrusion 720 and a recessed portion 770 in the core material 7 in the region R1 in FIG. 1. The side sectional view in FIG. 10B schematically illustrates a configuration example of a cross section and a back portion of the panel structure 2 cut at a position of an alternate long and short dash line B-B′ in FIG. 10A.

On the core material 7 according to the fourth embodiment, similarly to the core material 7 according to the first embodiment, the plurality of truncated triangular pyramid protrusions 720 protruding from the first main surface 710 are disposed on the first main surface 710. On the core material 7 according to the fourth embodiment, as illustrated in FIG. 10B, a plurality of truncated triangular pyramid protrusions 760 protruding from the second main surface 711 are disposed on the second main surface 711. The protrusions 760 on the second main surface 711 are formed by, for example, deforming a predetermined region of the sheet material 7S made of thermoplastic resin so as to protrude from the second main surface 711 in the second step S2 of producing the core material 7. In this example, as illustrated in FIGS. 10A and 10B, the recessed portion 770 that defines a space of a truncated triangular pyramid, which is similar or analogous to the protrusion 760 on the second main surface 711, is formed in the first main surface 710 of the core material 7. An area of a protrusion tip surface 761 of the protrusion 760 on the second main surface 711 can be set based on strength (degree of adhesion) when welded to the second surface material 6, and can be, for example, made identical to or approximately the same as the area of the protrusion tip surface 721 of the protrusion 720 on the first main surface 710. The protrusion 760 on the second main surface 711 has a smaller protrusion amount from the main surface than the protrusion 720 on the first main surface 710, and may have a height of, for example, about 1 mm to several mm from the second main surface 711. For example, when the second main surface 711 of the core material 7 is welded to the second surface material 6, the protrusion 760 on the second main surface 711 prevents an opening end of the recessed portion 730 in the core material 7 from being covered by the second surface material 6, thereby preventing the space in the recessed portion 730 from becoming a sealed space. For example, in the first welding step S501 of welding the second main surface 711 of the core material 7 to the second surface material 6, in a case in which the space in the recessed portion 730 in the core material 7 is closed by the second surface material 6 to become a sealed space, expansion and contraction of the air in the recessed portion 730 due to heating and cooling may occur. Therefore, there is a possibility that stress due to, for example, expansion and contraction of the air in the recessed portion 730 is generated at a welding interface between the second main surface 711 of the core material 7 and the second surface material 6.

On the other hand, in the core material 7 according to the fourth embodiment, by forming the protrusion 760 on the second main surface 711, a passage of air communicating with the recessed portion 730 can be provided between the core material 7 and the second surface material 6. Therefore, for example, it is possible to prevent delamination of the core material 7 due to stress generated at the welding interface between the second main surface 711 of the core material 7 and the second surface material 6 as a result of expansion of the air in the recessed portion 730.

The core material 7 according to the fourth embodiment can be formed by vacuum molding, pressure molding, or the like, similarly to the core material 7 according to the first embodiment. In addition, the core material 7 according to the fourth embodiment may be produced by, for example, press molding in which the sheet material 7S made of thermoplastic resin is sandwiched between a pair of molds including an upper mold and a lower mold. In the core material 7 according to the fourth embodiment, the shape of the protrusion on the first main surface 710 and the shape of the protrusion on the second main surface 711 may be a truncated quadrangular pyramid or a truncated cone. In the core material 7 according to the fourth embodiment, one or both of the protrusion on the first main surface 710 and the protrusion on the second main surface 711 may be columnar. Further, the protrusions provided on the second main surface 711 of the core material 7 are not limited to the protrusions arranged in a dotted shape as described above, and may be band-shaped.

### Fifth Embodiment

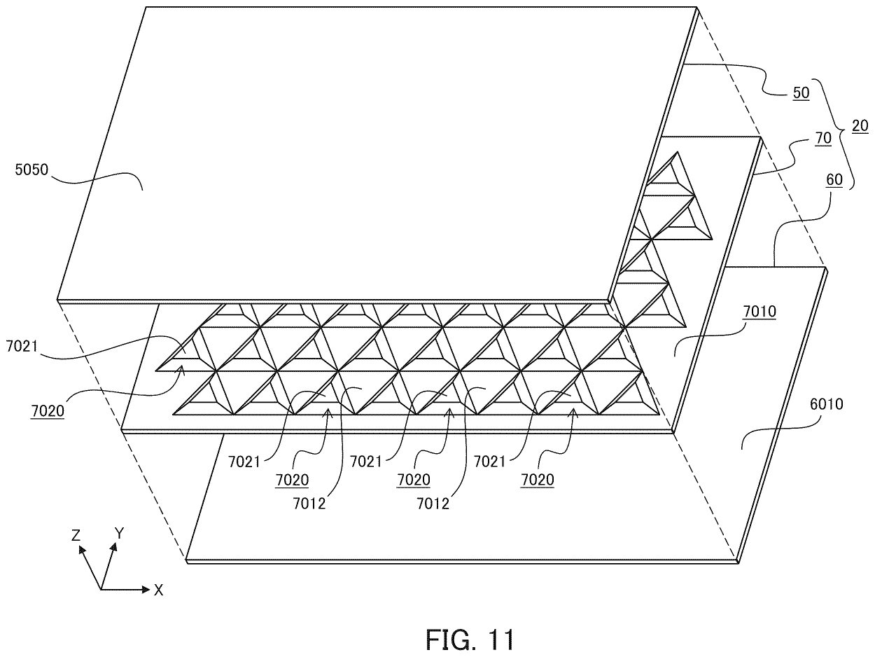

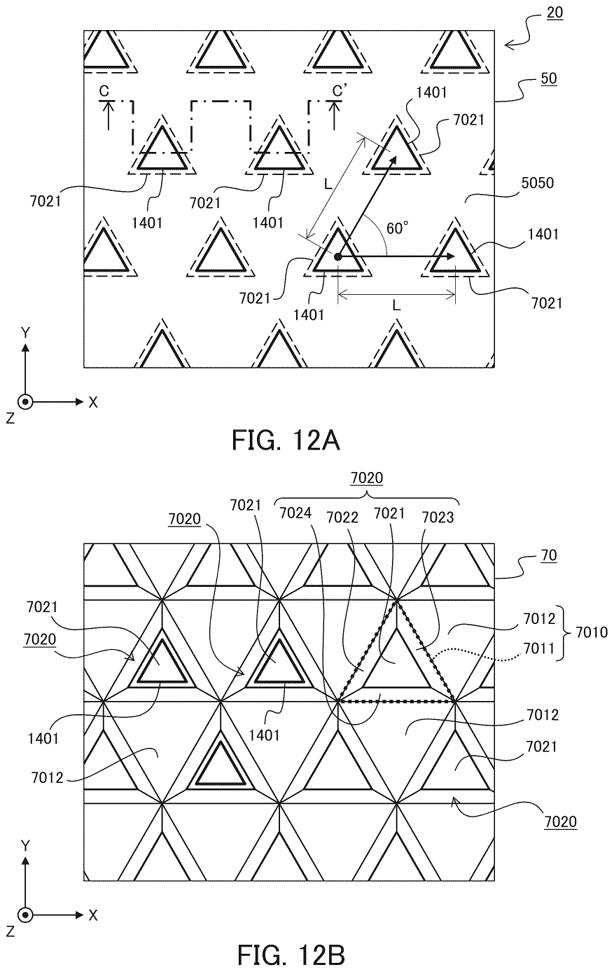

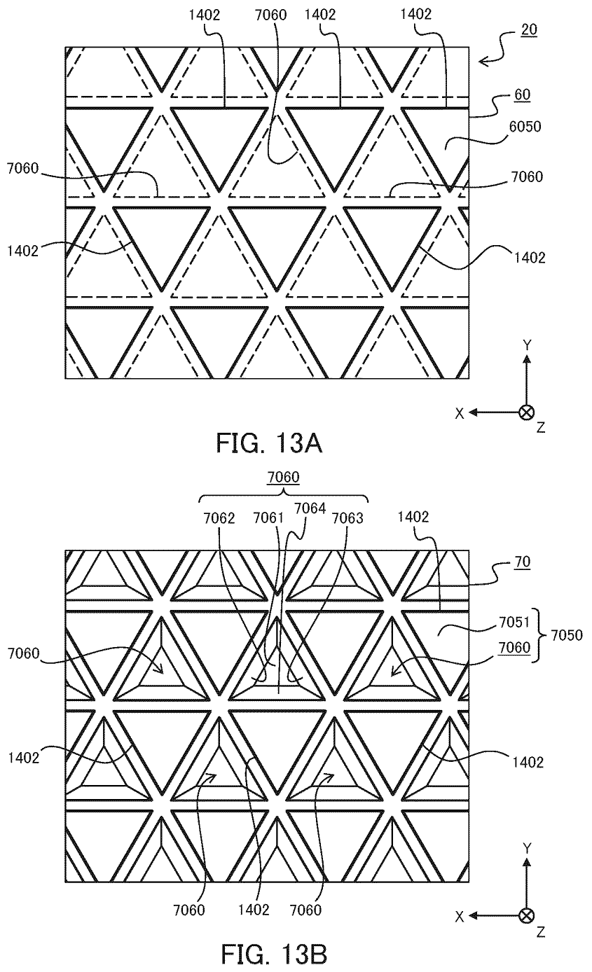

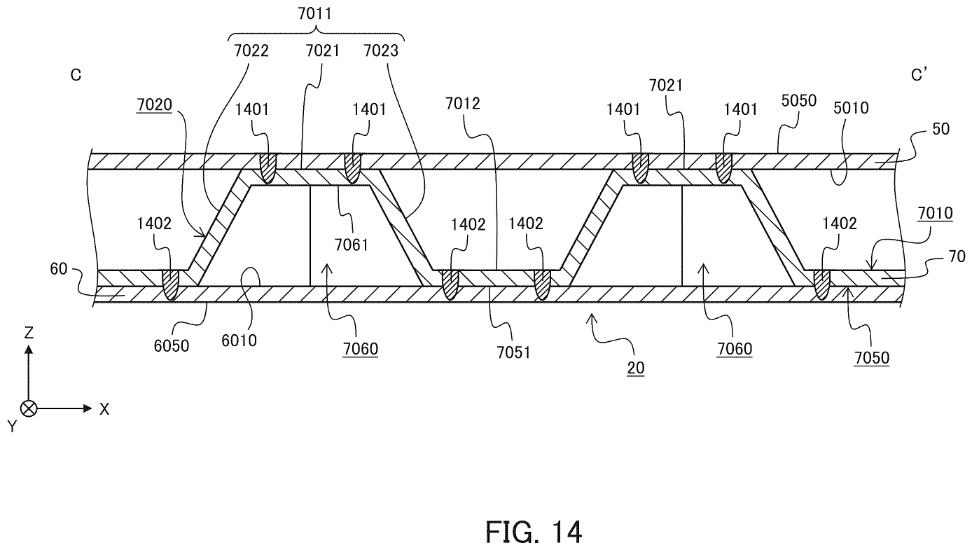

FIG. 11 is an exploded perspective view illustrating a configuration example of a panel structure according to a fifth embodiment. FIGS. 12A and 12B are plan views exemplifying shapes of a welded portion between a first surface material and a core material in the panel structure in FIG. 11. FIG. 12A illustrates a shape of the welded portion in a plan view of a front surface of the first surface material, and FIG. 12B illustrates a shape of the welded portion in a plan view of a surface of the core material facing the first surface material. FIGS. 13A and 13B are plan views exemplifying shapes of a welded portion between a second surface material and the core material in the panel structure in FIG. 11. FIG. 13A illustrates a shape of the welded portion in a plan view of a front surface of the second surface material, and FIG. 13B illustrates a shape of the welded portion in a plan view of a surface of the core material facing the second surface material. FIG. 14 is a side sectional view of the panel structure taken along an alternated long and short dash line C-C′ in FIG. 12A. The term “front surface” in the present specification is intended to mean a main surface that can be visually recognized from outside of a panel structure 20, among a pair of main surfaces located at ends in a plate thickness direction of a first surface material 50 and a second surface material 60. In other words, the “front surface” of each of the first surface material 50 and the second surface material 60 is intended to mean a main surface opposite to a main surface of each of the first surface material 50 and the second surface material 60, which faces a core material 70.

The panel structure 20 illustrated in FIG. 11 includes a pair of the surface materials 50 and 60 and the core material 70 disposed between the pair of surface materials 50 and 60. In the following description, one surface material 50 of the pair of surface materials 50 and 60 is referred to as a first surface material 50, and the other surface material 60 is referred to as a second surface material 60. The panel structure 20 can be applied to, for example, a door panel of a railway vehicle, a building, or the like. Furthermore, the panel structure 20 may be applied to, for example, a panel material constituting a housing of an electric board, a vending machine, a showcase, or the like, and a panel material of a partition or the like. The first surface material 50, the second surface material 60, and the core material 70 in the panel structure 20 according to the fifth embodiment may be formed with an opening region into which the window glass 4 is fitted, as in the panel structure 2 described above with reference to FIG. 2.

The first surface material 50, the second surface material 60, and the core material 70 in the panel structure 20 according to the fifth embodiment are each formed of a metal plate. The core material 70 is bonded to each of the first surface material 50 and the second surface material 60 by welding. More specifically, the core material 70 is bonded by laser welding or resistance welding. Therefore, the materials of the first surface material 50, the second surface material 60, and the core material 70 are not limited to specific metals, but are preferably metals suitable for laser welding or resistance welding. The first surface material 50, the second surface material 60, and the core material 70 are formed of, for example, a stainless steel plate, an iron plate (steel plate), an aluminum plate, an aluminum alloy plate, or the like. All the materials of the first surface material 50, the second surface material 60, and the core material 70 may or may not be the same metal. For example, the materials of the first surface material 50 and the second surface material 60 may be a first metal, and the material of the core material 70 may be a second metal different from the first metal.

For example, as illustrated in FIGS. 11, 12B, and 14, the core material 70 is provided with a plurality of protruding portions 7020 on a first main surface 7010. The first main surface 7010 of the core material 70 in the fifth embodiment refers to the entire surface facing a first main surface 5010 (refer to FIG. 14) of the first surface material 50, and includes a first bonding region 7011 and a second bonding region 7012.

The first bonding region 7011 is a region including a first welded portion 1401 welded to the first surface material 50 in a plan view (XY plan view) of the first main surface 7010, and more specifically, is an in-plane region forming each protruding portion 7020. The protruding portion 7020 may be referred to as a protrusion 7020. The protruding portion 7020 illustrated in FIGS. 11, 12B, and 14 has a shape referred to as a truncated triangular pyramid, and is provided on the first main surface 7010 of the core material 70 in a direction in which a triangular protrusion tip surface 7021 is substantially parallel to the first main surface 5010 of the first surface material 50. In this example, the first bonding region 7011 is represented by the protrusion tip surface 7021 of the protruding portion 7020 and three side surfaces 7022 to 7024 having a trapezoidal shape, which are connected to sides of the protrusion tip surface 7021. The first bonding region 7011 is similar to the protrusion tip surface 7021 in a plan view (XY plan view) of the first main surface 7010, and is a triangular region larger than the protrusion tip surface 7021. The plurality of protruding portions 7020 are disposed within the first main surface 7010 such that positions of centers of gravity of the protrusion tip surfaces 7021 of the respective protruding portions 7020 are arranged in the truss arrangement. In other words, the protruding portions 7020 are disposed on the first main surface 7010 such that the centers of gravity of the protrusion tip surfaces 7021 are arranged with intervals L therebetween in each of a first direction (X direction) in a plan view of the protrusion tip surface 7021 and a second direction inclined by 60 degrees with respect to the first direction. That is, on the first main surface 7010 of the core material 70, the plurality of first bonding regions 7011 are provided in the truss arrangement.

As illustrated in FIGS. 12A and 14, the first surface material 50 and the core material 70 are bonded to each other by the first welded portion 1401 in a first overlapping region where the protrusion tip surface 7021 of the protruding portion 7020 on the core material 70 and the first surface material 50 overlap each other in a plan view of a front surface 5050 (that is, a main surface opposite to the first main surface 5010) of the first surface material 50. The first welded portion 1401 is a portion bonded by welding, and includes a weld metal and a heat-affected zone. More specifically, the first welded portion 1401 is a portion bonded by seam welding along a contour (each side) of the first overlapping region in a plan view, and has a closed triangular ring shape. The “seam welding” in the present specification is intended to mean that welding is continuously performed in a linear manner on members to be bonded, and is not limited to seam welding as a type of resistance welding. The “seam welding” in the present specification may be laser seam welding in which laser welding is continuously performed in a linear manner.

The second bonding region 7012 is a region including a second welded portion 1402 welded to the second surface material 60 in a plan view (XY plan view) of the first main surface 7010, and more specifically, is a region of the first main surface 7010 excluding the first bonding region 7011. The second bonding region 7012 in the core material 70 illustrated in FIGS. 11, 12B, and 14 is a triangular region surrounded by sides of three first bonding regions 7011 adjacent to each other, and is separated from the first main surface 5010 of the first surface material 50.

The core material 70 is formed by, for example, deforming a plurality of regions in the flat first main surface 7010 of a metal plate such as a stainless plate or an aluminum plate by known press molding so as to protrude in a truncated triangular pyramid shape. In this example, as illustrated in FIGS. 13B and 14, a plurality of recessed surfaces 7060 are formed in a second main surface 7050 of the core material 70. The recessed surface 7060 may be referred to as a recessed portion 7060. The recessed surface 7060 is a surface defining a space having a truncated triangular pyramid shape corresponding to the protruding portion 7020 on the first main surface 7010 side, and includes a triangular bottom surface 7061 and three side surfaces 7062 to 7064 having a trapezoidal shape, which are connected to sides of the bottom surface 7061. The second main surface 7050 of the core material 70 refers to the entire surface facing the first main surface 6010 of the second surface material 60, and the core material 70 is bonded to the second surface material 60 by seam welding in a region of a flat surface 7051 excluding the recessed surface 7060 in the second main surface 7050. That is, the core material 70 illustrated in FIGS. 13A and 13B is bonded to the second surface material 60 by the second welded portion 1402 in the second overlapping region where the flat surface 7051 of the second main surface 7050 and the second surface material 60 overlap each other in a plan view of a front surface 6050 of the second surface material 60. The second welded portion 1402 is a portion bonded by seam welding along sides of three adjacent recessed surfaces 7060 of the second main surface 7050 of the core material 70 in a plan view, and has a closed triangular ring shape.

The plurality of protruding portions 7020 on the core material 70 have substantially the same height from the second bonding region 7012 of the first main surface 7010 to the protrusion tip surface 7021, and the protrusion tip surface 7021 of each of the protruding portions 7020 is seam-welded to the first surface material 50. The heights of the plurality of protruding portions 7020 are set according to, for example, thickness and interval of the first surface material 50 and the second surface material 60 in the panel structure 20 to be manufactured and thickness of the core material 70. A size of each protruding portion 7020, an area of the protrusion tip surface 7021, an arrangement interval of the protruding portions 7020, and the like can be set according to, for example, the application, required rigidity, and the like of the panel structure 20, and are not limited to specific values. As described later, a shape of the protruding portion 7020 in the core material 70 is not limited to a truncated triangular pyramid, and may be a truncated quadrangular pyramid, another truncated polygonal pyramid, or a truncated cone, or may be a prism such as a polygonal prism or a cylinder. Furthermore, the arrangement of the protruding portions 7020 may be any matrix shape, and is not limited to the truss arrangement.

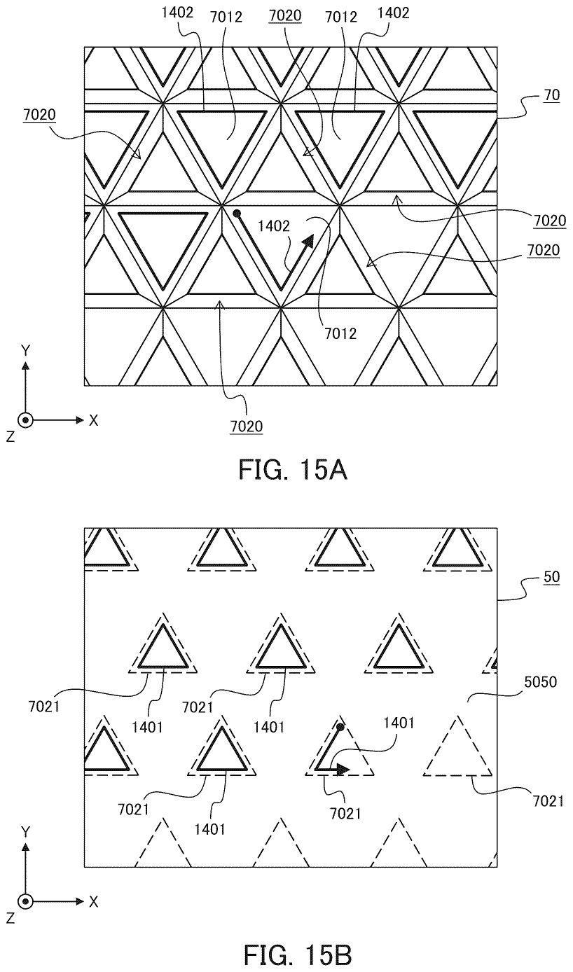

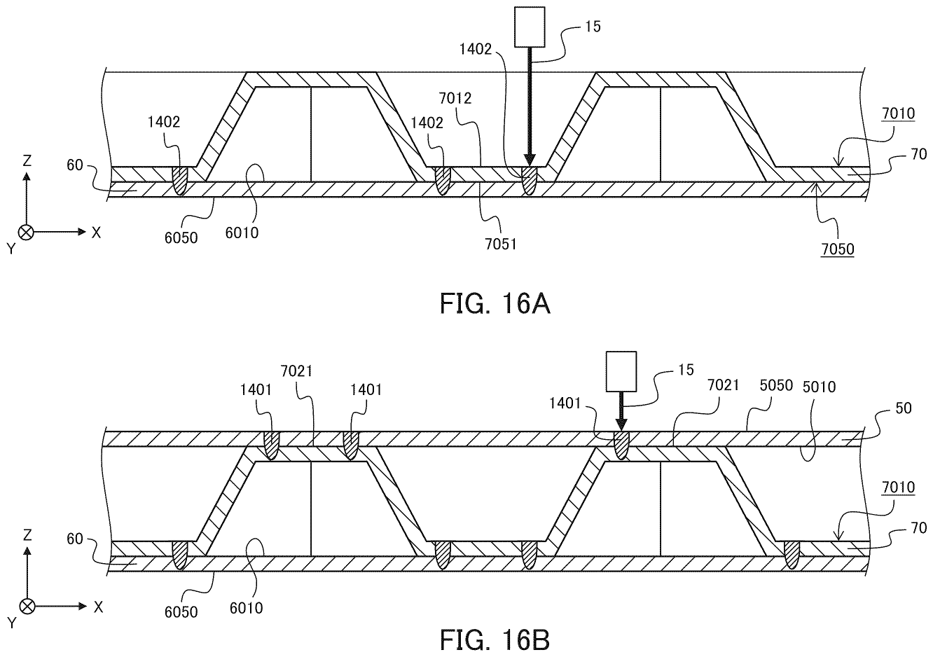

A manufacturing step of the panel structure 20 including the core material 70 according to the fifth embodiment includes a first welding step of bonding the first surface material 50 to the core material 70 by welding, and a second welding step of bonding the second surface material 60 to the core material 70 by welding. The “first welding step” and the “second welding step” in the present specification are intended only to distinguish whether the core material 70 is welded to the first surface material 50 or the second surface material 60. That is, in the manufacturing step of the panel structure 20, either the first welding step or the second welding step may be performed first. In the present specification, an example in which the second welding step is performed first will be described with reference to FIGS. 15A and 16A and FIGS. 15B and 16B. Note that a known step can be applied to the step of producing the first surface material 50 and the second surface material 60. The step of producing the core material 70 may be a step of forming the protruding portion 7020 on the first main surface 7010 (and the recessed surface 7060 in the second main surface 7050) by performing known press working on a metal plate serving as a base of the core material 70.

FIGS. 15A and 15B are plan views illustrating an example of a method of manufacturing the panel structure according to the fifth embodiment, and FIGS. 16A and 16B are side sectional views illustrating an example of the method of manufacturing the panel structure according to the fifth embodiment. FIG. 15A is a plan view illustrating an example of the second welding step, and FIG. 15B is a plan view illustrating an example of the first welding step. FIG. 16A is a side sectional view illustrating an example of the second welding step, and FIG. 16B is a side sectional view illustrating an example of the first welding step.

In a case in which the second welding step is performed first in the manufacturing step of the panel structure 20, first, as illustrated in FIGS. 15A and 16A, seam welding is performed with the second surface material 60 and the core material 70 overlapped with each other such that the first main surface 6010 of the second surface material 60 and the second main surface 7050 of the core material 70 face each other. In the second welding step, the second bonding region 7012 can be irradiated with a laser beam 15 for welding from the first main surface 7010 side of the core material 70. In this example, welding of the core material 70 and the second surface material 60 is continuously performed while moving an irradiation position of the laser beam 15 along a contour (side) of the second bonding region 7012 in the second bonding region 7012. For example, the irradiation position of the laser beam 15 is controlled to move in a triangular ring shape along each side from an irradiation start position located at a first corner portion of the triangular second bonding region 7012 and return to the irradiation start position. At this time, if the irradiation position of the laser beam 15 is moved so as to pass through a position as close as possible to the contour (side) of the second bonding region 7012, a distance between constraint points of the second surface material 60 by the second welded portion 1402 is shortened, and constraint force itself is increased, which is preferable. By irradiating the core material 70 with the laser beam 15 from the first main surface 7010 side, the irradiation position of the laser beam 15 can be controlled while confirming the position of a portion of the core material 70, which is to be welded to the second surface material 60. Therefore, for example, the irradiation position of the laser beam 15 can be reliably moved in the flat surface 7051 of the second main surface 7050 of the core material 70, and the second welded portion 1402 can be formed into a closed triangular ring shape. A wavelength, energy density, an irradiation diameter, and the like of the laser beam 15 irradiated in the second welding step can be selected according to, for example, a combination of materials, a plate thickness, a required bonding strength, and the like of the second surface material 60 and the core material 70. In the second welding step, the laser beam 15 may irradiate the front surface 6050 side of the second surface material 60. In a case in which the second welding step is performed first, for example, an electrode may be pressed against each of the first main surface 7010 of the core material 70 and the front surface 6050 of the second surface material 60 to bond the core material 70 to the second surface material 60 by resistance welding.

In a case in which the first welding step is performed after the second welding step, as illustrated in FIGS. 15B and 16B, seam welding is performed with the first surface material 50 and the core material 70 overlapped with each other such that the first main surface 7010 of the core material 70 and the first main surface 5010 of the first surface material 50 face each other. In this example, since the second surface material 60 is bonded to the second main surface 7050 side of the core material 70, the first surface material 50 is irradiated with the laser beam 15 for welding from the front surface 5050 side of the first surface material 50. The irradiation position of the laser beam 15 is controlled to move along a contour (side) of the protrusion tip surface 7021 in a region where the protrusion tip surface 7021 of the protruding portion 7020 on the core material 70 and the first surface material 50 overlap each other in a plan view (XY plan view) of the front surface 5050 of the first surface material 50. The irradiation position of the laser beam 15 is controlled, for example, to move in a triangular ring shape along each side from an irradiation start position located at a first corner portion of the triangular protrusion tip surface 7021 and return to the irradiation start position. For example, before the first surface material 50 is overlapped with the core material 70, a control device that controls the irradiation position of the laser beam 15 acquires information indicating a positional relationship between a representative portion (for example, a specific corner portion) on the first main surface 7010 of the core material 70 and a representative portion of the protrusion tip surface 7021 of each protruding portion 7020. Thereafter, the control device specifies and controls the irradiation position of the laser beam 15 based on the acquired information. At this time, if the irradiation position of the laser beam 15 is moved so as to pass through a position as close as possible to the contour (side) of the protrusion tip surface 7021, a distance between constraint points of the first surface material 50 by the first welded portion 1401 is shortened, and constraint force itself is increased, which is preferable.

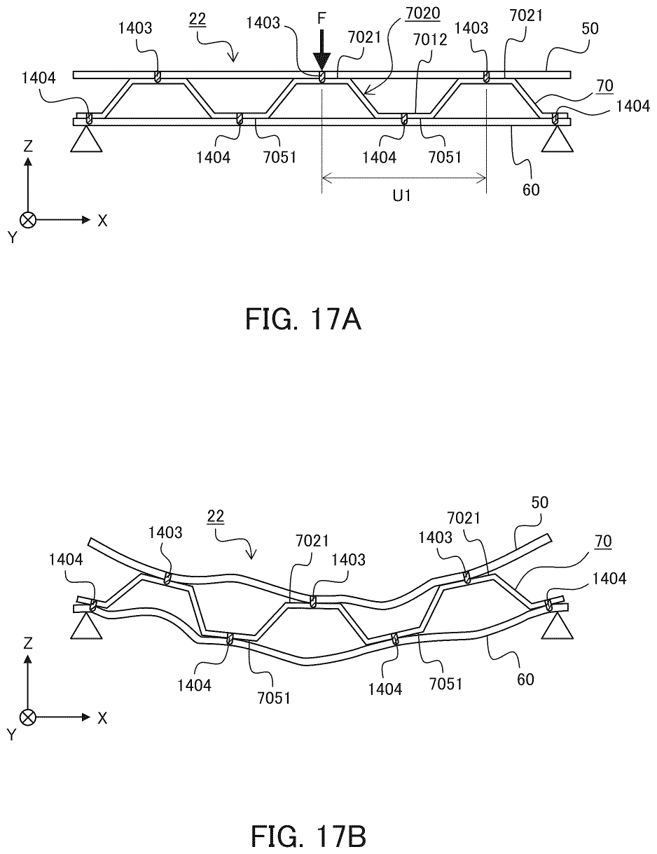

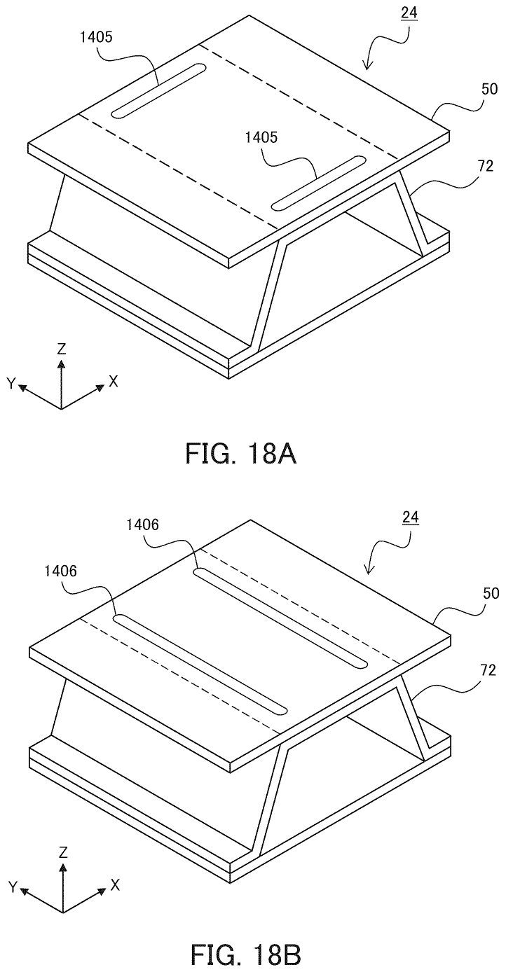

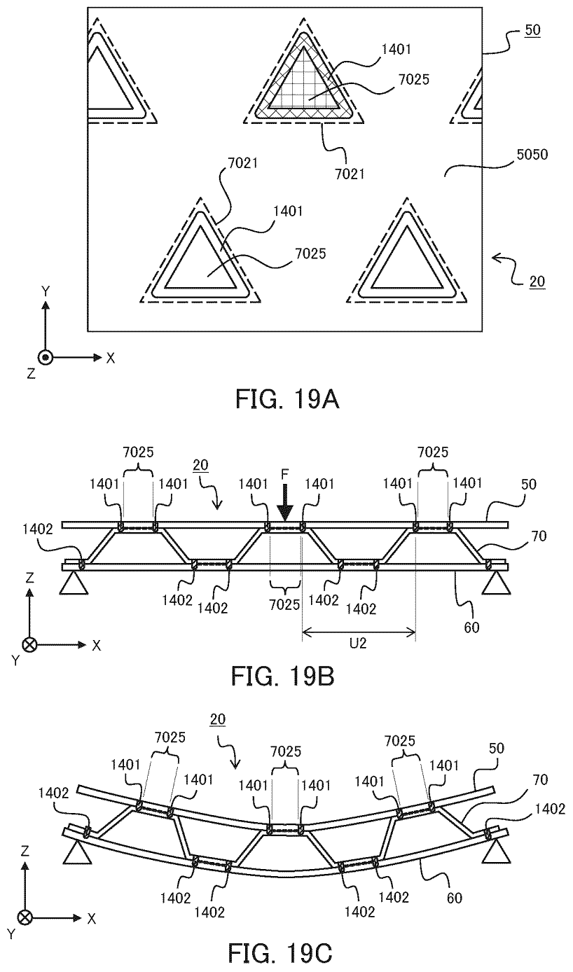

FIGS. 17A and 17B are diagrams illustrating rigidity of a panel structure in which a surface material and a core material are bonded to each other by spot welding. FIG. 17A illustrates a sectional view of the panel structure in which the surface material and the core material are bonded to each other by spot welding, and FIG. 17B illustrates deformation that occurs when a load is applied to the panel structure in FIG. 17A. FIGS. 18A and 18B are diagrams illustrating a conventional example of a panel structure in which a surface material and a core material are bonded to each other by seam welding. FIG. 18A illustrates a perspective view of the panel structure in which the surface material and the core material are bonded to each other by seam welding continuous in one direction (X direction), and FIG. 18B illustrates a perspective view of the panel structure in which the surface material and the core material are bonded to each other by seam welding continuous in another direction (Y direction) different from FIG. 18A. FIGS. 19A to 19C are diagrams illustrating rigidity of the panel structure according to the fifth embodiment. FIG. 19A illustrates a constraint region by seam welding in the panel structure, FIG. 19B illustrates a sectional view of the panel structure, and FIG. 19C illustrates deformation that occurs when a load is applied to the panel structure in FIG. 19B.

The panel structure 20 in which the core material 70 is disposed between the pair of surface materials 50 and 60 exhibits high rigidity against bending when the first surface material 50, the core material 70, and the second surface material 60 are integrated and can be deformed like one thick plate. Therefore, as a condition for increasing the rigidity of the panel structure 20, it is exemplified to prevent a distance between the first surface material 50 and the second surface material 60 from changing at any position of the panel structure 20. Specifically, it is exemplified that the core material 70 is not crushed, and each of the surface materials 50 and 60 is bonded to the core material 70 so as to be constrained at a short interval. For example, in the core material formed by a large number of regular hexagonal cells regularly arranged in JP 2016-29235 A, hexagonal shapes that are shapes resistant to compression and are in-plane filling shapes are densely spread, and the entire surface is bonded to the surface material, thereby constraining the surface material in a short span. However, when the amount of an adhesive for bonding the core material to the surface material is increased, a weight of the panel structure is increased.

Further, the core material 70 according to the fifth embodiment and the core material provided with a plurality of protrusions such as the core materials described in JP H10-166481 A and JP 2013-75451 A can be prevented from being crushed by selecting a plate thickness, a shape, a size, and the like of the protrusions. However, in a case in which the surface material and the core material are formed of metal and are bonded to each other by welding, the manner of welding affects rigidity of the panel structure 20. FIG. 17A illustrates a panel structure 22 in which the core material 70 is bonded to each of the first surface material 50 and the second surface material 60 by spot welding. Each of the plurality of protrusion tip surfaces 7021 in contact with the first surface material 50 in the core material 70 of the panel structure 22 is bonded to the first surface material 50 not by the first welded portion 1401 having a triangular ring shape (refer to FIG. 12B) but by a point-like welded portion 1403 located at the center of gravity of the triangle. The flat surface 7051 of the core material 70 of the panel structure 22, which is in contact with the second surface material 60, is bonded to the second surface material 60 not by the second welded portion 1402 having a triangular ring shape (refer to FIG. 13B) but by a point-like welded portion 1404 in a region surrounded by the three adjacent recessed surfaces 7060. The panel structure 22 illustrated in FIG. 17A is shorter in time required for welding and lower in cost than the panel structure 20 according to the fifth embodiment. However, a distance U1 between constraint points in the first surface material 50 is a distance between the point-like welded portions 1403. In addition, since the first surface material 50 is bonded to each of the plurality of protrusion tip surfaces 7021 by the point-like welded portion 1403, a portion of the first surface material 50, which is in contact with the protrusion tip surface 7021, is likely to be deformed to be separated from the protrusion tip surface 7021. The same applies to the second surface material 60 bonded to the core material 70 by the point-like welded portion 1404. Therefore, for example, in a case in which a downward load F is applied to the panel structure 22 from above the first surface material 50, as illustrated in FIG. 17A, the load F related to the panel structure 22 is substantially supported by the pair of surface materials 50 and 60. Therefore, in the panel structure 22 in which the core material 70 is bonded to each of the first surface material 50 and the second surface material 60 by spot welding, for example, as illustrated in FIG. 17B, the surface materials 50 and 60 may be freely deformed, and thus rigidity has a low value.

In addition, for example, even when the core material 70 is bonded to each of the first surface material 50 and the second surface material 60 by seam welding, an extending direction of the single welded portion affects the rigidity of the panel structure. FIGS. 18A and 18B illustrate a panel structure 24 in which a core material 72 bent into a corrugated shape and the first surface material 50 are bonded to each other by seam welding that is continuous in a direction (X direction) in which a plurality of peaks of the core material 72 are arranged. In FIG. 18A, one peak in the core material 72 is bonded by a welded portion 1405 that is continuous in the direction (X direction) in which the plurality of peaks are arranged at each of a plurality of places along an extending direction (Y direction) of the peak. In FIG. 18B, one peak in the core material 72 is bonded by a welded portion 1406 that is continuous in the extending direction (Y direction) of the peak at each of both ends in the direction (X direction) in which the plurality of peaks are arranged. Since the core material 72 in these panel structures 24 still constrains the first surface material 50 only by the welded portions 1405 or 1406 extending in one direction, there is a possibility that a portion between the adjacent welded portions 1405 or between the adjacent welded portions 1406 in one peak is locally deformed by a load, and it is difficult to increase rigidity of the first surface material 50.

On the other hand, in the panel structure 20 according to the fifth embodiment, as described above, the first welded portion 1401 for bonding the core material 70 to the first surface material 50 and the second welded portion 1402 for bonding the core material 70 to the second surface material 60 are seam-welded so as to have a closed triangular ring shape in a plan view. For this reason, for example, as illustrated in FIG. 19A, deformation of a portion of the first surface material 50, which overlaps a region 7025 surrounded by the first welded portion 1401 having a closed triangular ring shape on the protrusion tip surface 7021 of the core material 70, is also suppressed. In other words, the core material 70 and the first surface material 50 are bonded to each other such that each of the protrusion tip surfaces 7021 of the plurality of protruding portions 7020 on the core material 70 is in contact with the first surface material 50 and is constrained by a plurality of planar separate constraint regions corresponding to planar shapes of the protrusion tip surfaces 7021. That is, in the panel structure 20 according to the fifth embodiment, a region constrained by the core material 70 in the first surface material 50 bonded to the core material 70 by seam welding is larger than a region constrained by the welded portion 1403 of spot welding illustrated in FIGS. 17A and 17B. Therefore, in the panel structure 20 according to the embodiment, as illustrated in FIG. 19B, a distance U2 between constraint points of the first surface material 50 is shorter than the distance U1 (refer to FIG. 17A) between the constraint points in the case of spot welding. Although not illustrated, in the second surface material 60 welded to the core material 70 by the second welded portion 1402 having a closed triangular ring shape, deformation of a portion overlapping a region surrounded by the second welded portion 1402 is also suppressed. Therefore, a region of the second surface material 60, which is constrained by the core material 70, is larger than a region constrained by the welded portion 1404 of the spot welding illustrated in FIGS. 17A and 17B. Therefore, the panel structure 20 according to the fifth embodiment can have higher rigidity than the panel structure 22 or 24 in which the core material 70, the first surface material 50, and the second surface material 60 are bonded to each other by spot welding or seam welding that does not form a closed ring shape. When the downward load F is applied from the front surface 5050 side of the first surface material 50, the panel structure 20 according to the fifth embodiment can be deformed so that the distance between the first surface material 50 and the second surface material 60 at each position of the panel structure 20 does not change significantly, as illustrated in FIGS. 19B and 19C.

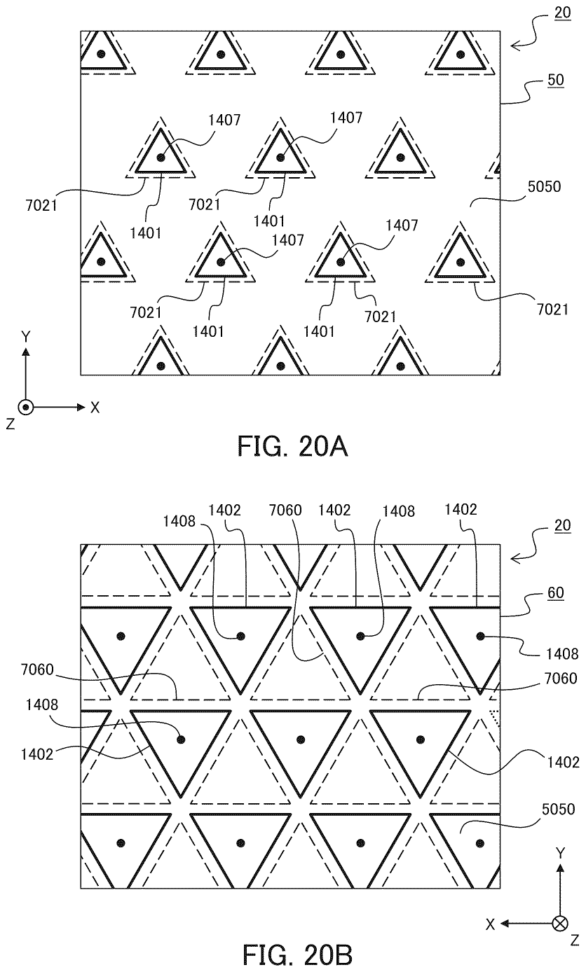

FIGS. 20A and 20B are diagrams illustrating additional welded portions in the panel structure according to the fifth embodiment. FIG. 20A illustrates the welded portion of the front surface 5050 of the first surface material 50 in a plan view, and FIG. 20B illustrates the welded portion of the front surface 6050 of the second surface material 60 in a plan view.

In the panel structure 20 according to the fifth embodiment, as illustrated in FIG. 20A, in the first surface material 50, an additional welded portion 1407 may be formed in a region surrounded by the first welded portion 1401 having a closed ring shape in a plan view of the front surface 5050. Similarly, as illustrated in FIG. 20B, in the second surface material 60, an additional welded portion 1408 may be formed in a region surrounded by the second welded portion 1402 having a closed ring shape in a plan view of the front surface 5050. The additional welded portion 1407 in FIG. 20A and the additional welded portion 1408 in FIG. 20B may be point-like welded portions formed by spot welding, but either or both of the additional welded portions 1407 and 1408 may be linear welded portions by seam welding.

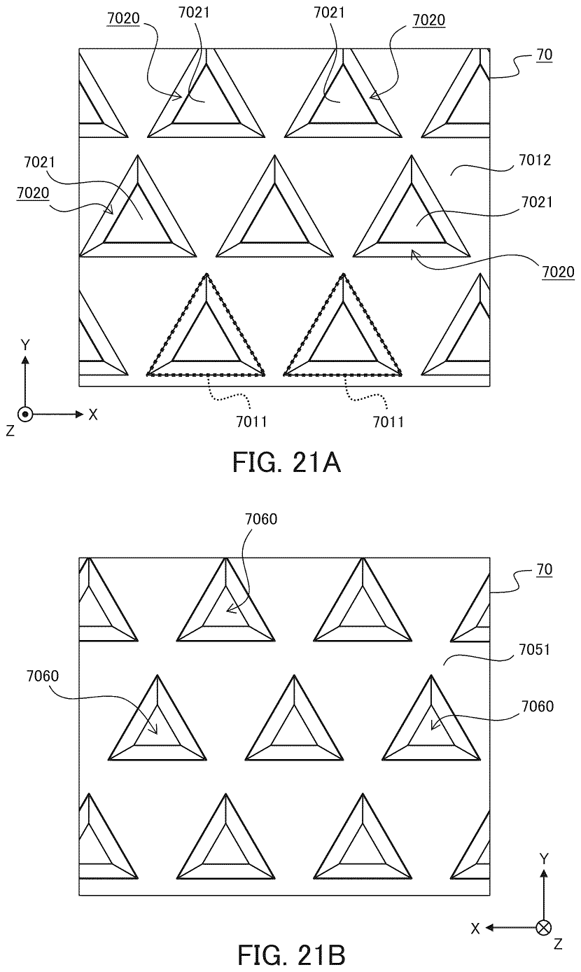

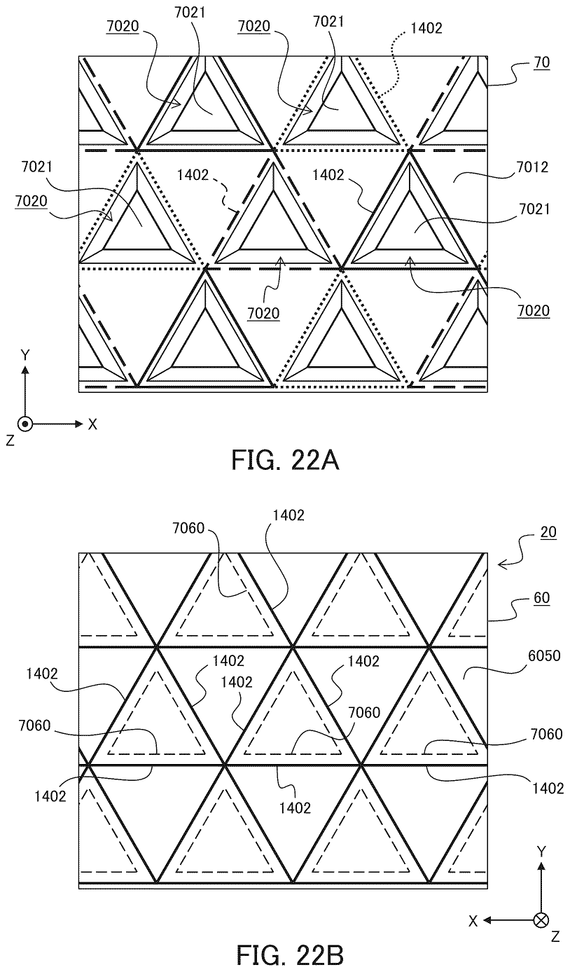

FIGS. 21A and 21B are diagrams illustrating a first modification of the arrangement of the protruding portions on the core material of the panel structure according to the fifth embodiment. FIGS. 22A and 22B are diagrams illustrating an example of seam welding between the second surface material and the core material in the panel structure using the core material exemplified in FIGS. 21A and 21B. FIG. 21A illustrates arrangement of the protruding portions 7020 in a plan view of the first main surface 7010 of the core material 70, and FIG. 21B illustrates arrangement of the recessed surfaces 7060 in a plan view of the second main surface 7050 of the core material 70. FIG. 22A illustrates a welding procedure in the second welding step of seam-welding the second surface material 60 and the core material 70, and FIG. 22B illustrates a shape of the second welded portion 1402 in a plan view of the front surface 6050 of the second surface material 60.

In the panel structure 20 according to the fifth embodiment, the protruding portion 7020 having a truncated triangular pyramid shape, which is provided on the core material 70, is not limited to the arrangement in which triangular corner portions representing a contour of the protruding portion 7020 are connected to each other in a plan view of the first main surface 7010, as illustrated in FIG. 12B. For example, as illustrated in FIG. 21A, the protruding portion 7020 having a truncated triangular pyramid shape may be disposed such that corners (vertices) of the protruding portions 7020 adjacent to each other in the first direction (X direction) and corners (vertices) of the protruding portions 7020 adjacent to each other in the second direction inclined by 60 degrees with respect to the first direction are separated from each other. In this example, in the recessed surface 7060 provided in the second main surface 7050 of the core material 70, similarly to the recessed surface 7060 illustrated in FIG. 13B, the corners (vertices) of the recessed surfaces 7060 adjacent to each other in the first direction are separated from each other, and the corners (vertices) of the recessed surfaces 7060 adjacent to each other in the second direction are separated from each other, but the respective distances are longer than those in the example of FIG. 13B. When such a core material 70 is used, in the second welding step, for example, as illustrated in FIG. 22A, seam welding surrounding the single protruding portion 7020 may be repeated to bond the second surface material 60 to the core material 70. In FIG. 22A, a solid triangle, a broken triangle, and a dotted triangle surrounding the protruding portion 7020 indicate movement paths of the irradiation position of the laser beam for forming the single second welded portion 1402 having a triangular ring shape, respectively. In this example, as illustrated in FIG. 22B, the corner portions of the three second welded portions 1402 adjacent to each other are connected to each other, and constraint force of the second surface material 60 by the core material 70 is increased as compared with the example illustrated in FIG. 13A, so that rigidity of the panel structure 20 can be further increased. In addition, bonding of the second surface material 60 and the core material 70 exemplified in FIG. 22A may be performed by, for example, performing seam welding continuously over the sides of the plurality of protruding portions 7020 in the first direction (X direction), performing seam welding continuously over the sides of the plurality of protruding portions 7020 in the second direction (a direction rotated by 60 degrees counterclockwise from the X direction), and performing seam welding continuously over the sides of the plurality of protruding portions 7020 in a third direction (a direction rotated by 60 degrees clockwise from the X direction), instead of repeating seam welding having a triangular ring shape surrounding the protruding portion 7020.

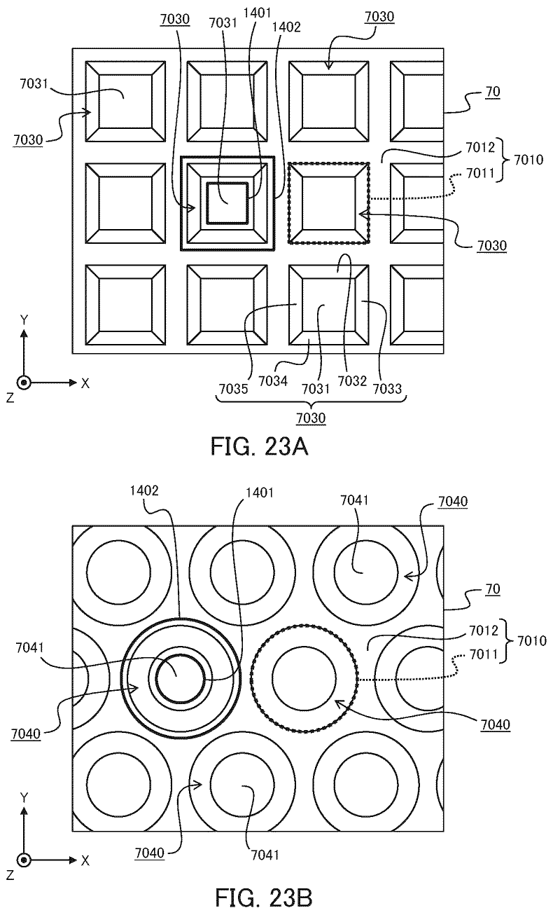

FIGS. 23A and 23B are diagrams illustrating another modification of the shape and arrangement of the protruding portions on the core material of the panel structure according to the fifth embodiment. FIG. 23A illustrates the core material 70 in which a truncated quadrangular pyramid protruding portion 7030 is disposed, and FIG. 23B illustrates the core material 70 in which a truncated conical protruding portion 7040 is disposed.

On the first main surface 7010 of the core material 70, for example, as illustrated in FIG. 23A, the truncated quadrangular pyramid protruding portion 7030 may be disposed. The truncated quadrangular pyramid protruding portion 7030 includes a protrusion tip surface 7031 and four side surfaces 7032 to 7035 having a trapezoidal shape, which are connected to sides of the protrusion tip surface 7031. The protrusion tip surface 7031 of the truncated quadrangular pyramid protruding portion 7030 is a quadrangle (square), and is welded to the first surface material 50 (not illustrated) by seam welding along each of the four sides. That is, in a case in which the core material 70 provided with the truncated quadrangular pyramid protruding portion 7030 is used, the protrusion tip surface 7031 is welded to the first surface material 50 by the first welded portion 1401 having a closed quadrangular ring shape. In addition, in a case in which the truncated quadrangular pyramid protruding portion 7030 is provided, for example, as illustrated in FIG. 23A, the core material 70 and the second surface material 60 (not illustrated) are welded to each other by the second welded portion 1402 having a closed quadrangular ring shape surrounding the quadrangular (square) first bonding region 7011 on the first main surface 7010 of the core material 70. In the truncated quadrangular pyramid protruding portion 7030 illustrated in FIG. 23A, the sides of the protrusion tip surface 7031 are arranged in a direction in which the sides extend in the first direction (the X direction) on the first main surface 7010 and the sides extend in the second direction (the Y direction) orthogonal to the first direction in a plan view of the protrusion tip surface 7031. However, the truncated quadrangular pyramid protruding portion 7030 may be disposed, for example, in a direction (refer to FIG. 8B) in which the sides of the protrusion tip surface 7031 in a plan view are a side extending in a direction inclined 45 degrees clockwise from the first direction and a side extending in a direction inclined 45 degrees counterclockwise from the first direction.

Further, on the first main surface 7010 of the core material 70, for example, as illustrated in FIG. 23B, the truncated conical protruding portion 7040 may be disposed. A protrusion tip surface 7041 of the truncated conical protruding portion 7040 is circular, and is welded to the first surface material 50 (not illustrated) by seam welding along a circumference. That is, in a case in which the core material 70 provided with the truncated conical protruding portion 7040 is used, the protrusion tip surface 7041 is welded to the first surface material 50 by the first welded portion 1401 having a closed circular ring shape. In addition, when the truncated conical protruding portion 7040 is provided, for example, as illustrated in FIG. 23B, the core material 70 and the second surface material 60 (not illustrated) are welded to each other by the second welded portion 1402 having a closed circular ring shape surrounding the circular first bonding region 7011 on the first main surface 7010 of the core material 70.

The shape of the protruding portion disposed on the first main surface 7010 of the core material 70 is not limited to the above-described truncated triangular pyramid, truncated quadrangular pyramid, and truncated cone. The shape of the protruding portion disposed on the first main surface 7010 may be another truncated polygonal pyramid, or may be a columnar shape such as a triangular prism or a cylinder. In addition, the core material 70 of the panel structure 20 according to the fifth embodiment may have, for example, a configuration similar to that of the core material of JP H10-166481 A, in which the first main surface 7010 has a protruding portion protruding toward the first surface material 50 and the second main surface 7050 has a protruding portion protruding toward the second surface material 60. Further, for example, an area and an arrangement density of the protrusion tip surface of the core material 70 may be changed according to the position in first main surface 7010.

In the above-described fifth embodiment, the panel structure 20 in which the first surface material 50, the second surface material 60, and the core material 70 are formed of metal plates and welded by seam welding is exemplified. More specifically, in the panel structure 20 of the fifth embodiment, the first welded portion 1401 that bonds the first surface material 50 to the core material 70 and the second welded portion 1402 that bonds the second surface material 60 to the core material 70 are welded so as to have a closed ring shape. However, each of the first welded portion 1401 and the second welded portion 1402 may be regarded as a substantially closed ring shape. Therefore, the “closed ring shape” in the present specification can include a case in which, when a length of one welded portion along the contour (side) of the protrusion tip surface 7021 is compared with a distance between one end and the other end of the one welded portion, the distance between one end and the other end of the welded portion is sufficiently smaller than the length of the welded portion. In addition, the panel structure 20 according to the fifth embodiment is not limited to a panel structure for a specific application as described above. Therefore, in the panel structure 20, for example, the first surface material 50, the second surface material 60, and the core material 70 may be formed of thermoplastic resin and may be welded by seam welding.

The above-described embodiments are specific examples to facilitate understanding of the invention, and the embodiments of the panel structures 2 and 20 according to the present invention are not limited to the above-described embodiments. The panel structure, the door panel, and the method of manufacturing the panel structure according to the present invention may be variously changed, replaced, or modified without departing from the spirit of the technical idea. Furthermore, when the technical idea can be realized in another manner by the progress of the technology or another derived technology, the present invention may be implemented using the method. Therefore, the claims cover all implementations that may be included within the scope of the technical idea.

Hereinafter, feature points in the above-described embodiments will be summarized.

The panel structure according to the above-described embodiment includes a pair of surface materials, and a core material disposed between the pair of surface materials, the core material formed to have a plurality of protrusions arranged in a matrix on a first main surface facing one surface material of the pair of surface materials, in which the core material has a shape in which each of a plurality of separate regions in a flat plate-like member is deformed from the first main surface toward the one surface material side, each of the plurality of protrusions has a protrusion tip surface facing the one surface material, and the core material and the one surface material are bonded to each other such that each of the protrusion tip surfaces of the plurality of protrusions on the core material is in contact with the one surface material and is constrained by a plurality of planar separate constraint regions corresponding to planar shapes of the protrusion tip surfaces.

In the panel structure according to the above-described embodiment, the core material is formed of thermoplastic resin, and each of the protrusion tip surfaces of the plurality of protrusions on the core material is welded to the one surface material.

In the panel structure according to the above embodiment, the core material has a plurality of recessed portions recessed from a second main surface opposite to the first main surface toward the protrusion tip surfaces, and the second main surface is welded to the other surface material of the pair of surface materials.

In the panel structure according to the above embodiment, the protrusion tip surface of the core material, which is welded to the one surface material, has a polygonal shape or a circular shape.

In the panel structure according to the above embodiment, the pair of surface materials is formed of a material having a higher melting point than a melting point of the thermoplastic resin.

In the panel structure according to the above embodiment, the core material and the one surface material are bonded to each other by a welded portion forming a ring shape along a contour of a region in which the protrusion tip surface and the one surface material overlap each other in a plan view of the protrusion tip surface of the core material in the region.

In the panel structure according to the above embodiment, the core material has a plurality of recessed surfaces recessed toward the protrusion tip surfaces, the recessed surfaces being formed in a second main surface opposite to the first main surface, and the core material and the other surface material of the pair of surface materials are bonded to each other by a welded portion forming a ring shape along a contour of the recessed surface in a region of the second main surface excluding the recessed surface in a plan view of the second main surface of the core material.

In the panel structure according to the above embodiment, the plurality of protrusions on the core material are arranged in a truss arrangement on the first main surface.

The panel structure according to the above embodiment includes an additional welded portion in at least one of a region surrounded by the welded portion forming the ring shape for bonding the core material to the one surface material and a region surrounded by the welded portion forming the ring shape for bonding the core material to the other surface material.

In the panel structure according to the above embodiment, each of the pair of surface materials and the core material is formed of metal.

A door panel according to the above-described embodiment includes a panel structure including a core material disposed between a pair of surface materials, in which the core material has a plurality of protrusions arranged in a matrix on a first main surface facing one surface material of the pair of surface materials, the core material has a shape in which each of a plurality of separate regions in a flat plate-like member is deformed from the first main surface toward one the surface material side, each of the plurality of protrusions has a protrusion tip surface facing the one surface material, and the core material and the one surface material are bonded to each other such that each of the protrusion tip surfaces of the plurality of protrusions on the core material is in contact with the one surface material and is constrained by a plurality of planar separate constraint regions corresponding to planar shapes of the protrusion tip surfaces.

A method of manufacturing a panel structure according to the above-described embodiment is a method of manufacturing a panel structure including a core material disposed between a pair of surface materials, in which the core material has a plurality of protrusions arranged in a matrix on a first main surface facing one surface material of the pair of surface materials, the core material has a shape in which each of a plurality of separate regions in a flat plate-like member is deformed from the first main surface toward the one surface material side, each of the plurality of protrusions has a protrusion tip surface facing the one surface material, and the method of manufacturing the panel structure includes a bonding step of bonding the core material to the one surface material such that each of the protrusion tip surfaces of the plurality of protrusions on the core material is in contact with the one surface material and is constrained by a plurality of planar separate constraint regions corresponding to planar shapes of the protrusion tip surfaces.

In the method of manufacturing a panel structure according to the above embodiment, the bonding step includes a welding step of welding each of the protrusion tip surfaces of the plurality of protrusions on the core material formed of thermoplastic resin to the one surface material.

In the method of manufacturing a panel structure according to the above embodiment, the core material has a plurality of recessed portions recessed from a second main surface opposite to the first main surface toward the protrusion tip surfaces, and the bonding step includes a step of welding the second main surface of the core material to the other surface material of the pair of surface materials.

In the method of manufacturing a panel structure according to the above embodiment, the pair of surface materials is formed of a material having a higher melting point than a melting point of the thermoplastic resin.

In the method of manufacturing a panel structure according to the above embodiment, when the core material is welded to each of the pair of surface materials, the core material is heated to a temperature higher than a melting point of the core material and lower than a melting point of the surface material.

In the method of manufacturing a panel structure according to the above embodiment, the bonding step includes a welding step of bonding the core material to the one surface material by welding, and in the welding step, the core material and the one surface material are welded to each other such that a welded portion between the core material and the one surface material forms a ring shape along a contour of a region in which the protrusion tip surface and the one surface material overlap each other in a plan view of the protrusion tip surface of the core material in the region.

What is claimed is:

1. A panel structure comprising:
a first surface plate and a second surface plate forming a pair; and
a core plate disposed between the first and second surface plates, the core plate having a plurality of protrusions arranged in a matrix on a first main surface thereof facing the first surface plate, wherein
each of the plurality of protrusions has a protrusion tip surface facing the first surface plate, and
the core plate and the first surface plate are bonded to each other such that each of the protrusion tip surfaces is in contact with the first surface plate and is constrained by a plurality of planar separate constraint regions corresponding to a planar shape of said each protrusion tip surface.

2. The panel structure according to claim 1, wherein
the core plate is formed of a thermoplastic resin, and
each of the protrusion tip surfaces is welded to the first surface material.

3. The panel structure according to claim 2, wherein
the core plate further has a second main surface, opposite to the first main surface, welded to the second surface plate, the second main surface having a plurality of recessed portions formed therein.

4. The panel structure according to claim 2, wherein
the protrusion tip surface of the core plate, which is welded to the first surface plate, has a polygonal shape or a circular shape.

5. The panel structure according to claim 2, wherein
the first and second surface plates are formed of a material having a higher melting point than a melting point of the thermoplastic resin.

6. The panel structure according to claim 1, wherein
the protrusion tip surface and the first surface plate overlap each other in an overlapping region when viewed in an angle perpendicular to the core plate, and
the core plate and the first surface plate are bonded to each other by a welded portion forming a ring shape along a contour of the overlapping region.

7. The panel structure according to claim 6, wherein
the core plate further has a second main surface opposite to the first main surface, the second main surface having a plurality of recessed portions formed therein, and
the core plate and the second surface plate are bonded to each other by another welded portion forming another ring shape along a contour of each of the plurality of recessed portions on the second main surface.

8. The panel structure according to claim 6, wherein the plurality of protrusions on the core plate are formed in a truss arrangement on the first main surface.

9. The panel structure according to claim 7, further comprising an additional welded portion in at least one of
a first region surrounded by the welded portion forming the ring shape for bonding the core material to the first surface plate, and
a second region surrounded by the another welded portion forming the another ring shape for bonding the core material to the second surface plate.

10. The panel structure according to claim 6, wherein each of the first and second surface plates and the core plate is formed of metal.

11. A door panel, comprising:
a panel structure including a core plate disposed between first and second surface plates forming a pair of, wherein
the core plate has a plurality of protrusions arranged in a matrix on a first main surface thereof facing the first surface plate,
each of the plurality of protrusions has a protrusion tip surface facing the first surface plate, and
the core material and the first surface plate are bonded to each other such that each of the protrusion tip surfaces is in contact with the first surface plate and is constrained by a plurality of planar separate constraint regions corresponding to a planar shape of said each protrusion tip surface.

12. A method of manufacturing a panel structure including a core plate disposed between first and second surface plates forming a pair, wherein
the core plate has a plurality of protrusions arranged in a matrix on a first main surface thereof facing the first surface plate,
each of the plurality of protrusions has a protrusion tip surface facing the first surface plate,
the method comprising:
a bonding step of bonding the core plate to the first surface plate such that each of the protrusion tip surfaces is in contact with the first surface material and is constrained by a plurality of planar separate constraint regions corresponding to a planar shape of said each protrusion tip surface.

13. The method of manufacturing the panel structure according to claim 12, wherein
the bonding step further includes a welding step of welding each of the protrusion tip surfaces to the first surface material, wherein the core plate is formed of a thermoplastic resin.

14. The method of manufacturing the panel structure according to claim 13, wherein
the core further has a second main surface opposite to the first main surface, the second main surface having a plurality of recessed portions formed therein, and
the bonding step further includes a step of welding the second main surface of the core material to the second surface plate.

15. The method of manufacturing the panel structure according to claim 13, wherein
the first and second surface plates are formed of a material having a higher melting point than a melting point of the thermoplastic resin.

16. The method of manufacturing the panel structure according to claim 13, further comprising
heating, when the core plate is welded to each of the first and second surface plates, the core plate to a temperature higher than a melting point of the core plate and lower than a melting point of the first and second surface plates.

17. The method of manufacturing the panel structure according to claim 12, wherein
the bonding step further includes a welding step of bonding the core plate to the first surface plate by welding, and
in the welding step, the core plate and the first surface plate are welded to each other such that a welded portion between the core plate and the first surface plate forms a ring shape along a contour of an overlapping region of the protrusion tip surface and the first surface plate overlap when viewed in an angle perpendicular to the core plate.
